(19) United States
(12) Patent Application Publication
(10) Pub. No.: US 2025/0051492 A1
(43) Pub. Date: Feb. 13, 2025

(54) DEVOLATILIZATION OF ETHYLENE/a-OLEFIN COPOLYMER PELLETS

(71) Applicant: NOVA CHEMICALS (INTERNATIONAL) S.A., Fribourg (CH)

(72) Inventors: Abolfazl NOORJAHAN, Calgary (CA); Soheil SADEGHI, Calgary (CA); Marcia PIRES FORTES FERREIRA, Calgary (CA); Mehrnaz RAHIMI, Calgary (CA)

(73) Assignee: NOVA CHEMICALS (INTERNATIONAL) S.A., Fribourg (CH)

(21) Appl. No.: 18/721,073

(22) PCT Filed: Dec. 16, 2022
(86) PCT No.: PCT/IB2022/062418

§ 371 Date: Jun. 17, 2024

Related U.S. Application Data
(60) Provisional application No. 63/291,870, filed on Dec. 20, 2021.

(51) Int. Cl. C08F 6/28; C08F 210/02; C08F 210/14

(52) U.S. Cl. CPC C08F 6/28; C08F 210/02; C08F 210/14

(57) ABSTRACT

Pellets of ethylene/a-olefin copolymer are devolatilized using nitrogen in a devolatilization bin via a multistep process. Said multistep process, among other things, comprises providing nitrogen gas to the devolatilization bin at a first nitrogen inlet temperature (I) less than VICAT softening temperature of the ethylene/α-olefin copolymer for a first period of time t₁ to form a new peak melting peak (II) greater than (I) and smaller than a highest peak melting temperature Tₘ of the ethylene/α-olefin copolymer. The devolatilization process is continued by raising and holding the nitrogen gas temperature provided to said devolatilization bin at a second nitrogen inlet temperature (III) for a second period of time t₂ subsequent to the first period of time t₁, wherein (III) is greater than (I) and less than (II).

### TECHNICAL FIELD

Disclosed herein is a process for devolatilization of ethylene/α-olefin copolymer pellets to a target residual hydrocarbons level, comprising providing nitrogen gas at a first nitrogen inlet temperature (T_{N}^{inlet})¹ for a first period of time t₁ followed by raising and holding the nitrogen gas temperature at a second nitrogen inlet temperature (T_{N}^{inlet})² for a second period of time t₂ subsequent to the first period of time t₁, wherein (T_{N}^{inlet}) is greater than (T_{N}^{inlet})¹.

### BACKGROUND ART

Devolatilization using a stripping agent such as air, nitrogen, gaseous hydrocarbon, etc. is a known technique for the removal of volatile hydrocarbon residues from solid polymer particles. It is known to those of ordinary experience that it is desired to heat the polymer particles to accelerate the desorption process of hydrocarbon residues and to reduce the holdup time required to strip the polymer particles form hydrocarbon residues. However, for a given polymer composition, there is an upper limit for the devolatilization temperature where polymer particles start forming adhesive contacts. As a result, there is still a need to develop a process for the production of devolatilized solid polymer particles where the onset of adhesive contacts between polymer particles is postponed to higher temperatures enabling devolatilization at an accelerated rate.

### SUMMARY OF INVENTION

Provided in one embodiment of this disclosure is a process for devolatilization of ethylene/α-olefin copolymer pellets, wherein the ethylene/α-olefin copolymer has a VICAT softening temperature (VSP) measured by ASTM D1525-17 and a highest peak melting temperature Tₘ, wherein the process comprises:
a) filling a devolatilization bin at a filling time t_{f} with the ethylene/α-olefin copolymer pellets, wherein the ethylene/α-olefin copolymer pellets are characterized by containing greater than or equal to 1 weight % of residual volatile hydrocarbons;
b) providing nitrogen gas to the devolatilization bin at a first nitrogen inlet temperature (T_{N}^{inlet})¹ for a first period of time t₁ subsequent to the filling time t_{f}, wherein (T_{N}^{inlet})¹ is greater than VSP−30° C. and less than the VSP of the ethylene/α-olefin copolymer and wherein the first period of time t₁ is sufficient to form a new peak melting temperature Tₘ¹ in the ethylene/α-olefin copolymer, wherein Tₘ¹ is greater than (T_{N}^{inlet})¹ and less than the highest peak melting temperature Tₘ;
c) raising and holding the nitrogen gas temperature provided to the devolatilization bin at a second nitrogen inlet temperature (T_{N}^{inlet})² for a second period of time t₂ subsequent to the first period of time t₁, wherein (T_{N}^{inlet})² is greater than (T_{N}^{inlet})¹ and less than Tₘ¹; and
d) discharging the ethylene/α-olefin copolymer pellets from the devolatilization bin at a third period of time t₃ subsequent to the second period of time t₂;
   wherein the ethylene/α-olefin copolymer pellets contain less than or equal to 150 parts per million of the residual volatile hydrocarbons after a holdup time (HUT) corresponding to sum of the filling time in the step a), the first period of time t₁ in the step b), the second period of time t₂ in the step c) and the third period of time t₃ in the step d).

In an embodiment of the disclosure, the ethylene/α-olefin copolymer has a density of from 0.865 to 0.905 g/cm³ as measured by ASTM D1505 and a melt index MI₂ of from 0.3 to 30 dg/min as measured by ASTM D1238 at a temperature of 190° C. using a 2.16 kg load.

In an embodiment of the disclosure, the first nitrogen inlet temperature (T_{N}^{inlet})¹ is greater than VSP−15° C. and less than or equal to VSP−5° C. In an embodiment of the disclosure, the first nitrogen inlet temperature (T_{N}^{inlet})¹ is from 40° C. to 85° C. or from 40° C. to 70° C.

In an embodiment of the disclosure, the ethylene/α-olefin copolymer pellets entering the devolatilization bin are characterized by containing less than or equal to 5 weight % of the residual volatile hydrocarbons.

In an embodiment of the disclosure, the new peak melting temperature Tₘ¹ is from 5 to 15° C. above the first nitrogen inlet temperature (T_{N}^{inlet})¹. In an embodiment of the disclosure, the first period of time t₁ is sufficient to increase elastic modulus of the ethylene/α-olefin copolymer by at least 15%.

In an embodiment of the disclosure, the ethylene/α-olefin copolymer comprises ethylene and at least one α-olefin selected from the group consisting of 1-butene, 1-hexene and 1-octene.

In an embodiment of the disclosure, the ethylene/α-olefin copolymer pellets are not fluidized in the devolatilization bin during the first period of time and the second period of time.

In an embodiment of the disclosure, the devolatilization bin has a top end wall and a bottom end wall, and a continuous sidewall therebetween, and wherein the nitrogen gas is continuously provided to a first area proximal the bottom end wall using a plurality of feed nozzles as an upward flow to the devolatilization bin at a mass flow rate from 2 weight % to 15 weight % per hour, based on the total weight of ethylene/α-olefin copolymer pellets in the devolatilization bin.

In an embodiment of this disclosure, the ethylene/α-olefin copolymer has a density from 0.865 to 0.900 g/cm³ as measured by ASTM D1505 and wherein an amount of ethylene/α-olefin copolymer pellets are periodically recirculated from a second area proximal to the bottom end wall of the devolatilization bin to a third area proximal to the top end wall of the devolatilization bin during any or both of the steps b) and c) using a conveying means external to the devolatilization bin, wherein the conveying means extends from a first opening positioned adjacent the second area proximal the bottom end wall of the devolatilization bin to a second opening positioned adjacent the third area proximal to the top end wall of the devolatilization bin.

In an embodiment of this disclosure, the amount of ethylene/α-olefin copolymer pellets that are recirculated is from about 0.5% to about 5% of the total weight of ethylene/α-olefin copolymer pellets are recirculated over a recirculation time of 10 minutes at least every 8 hours for the ethylene/α-olefin copolymer density range from 0.865 to 0.885 g/cm³ or at least every 16 hours for the ethylene/α-olefin copolymer density range from 0.885 to 0.900 g/cm³.

In an embodiment of this disclosure, the conveying means is a pneumatic conveying means which uses nitrogen gas as motive gas

### BRIEF DESCRIPTION OF THE FIGURES

FIGS. 1a(1) through 1d(2) display the temporal evolution of VOC components characterized in Examples 1a through 1d at three sampling locations along the height of the Test Stripper: namely SP1, SP2 and SP3. The concentration of the first VOC component (2-methylpentane) and the second VOC component (1-octene) are denoted as C₁ and C₂, respectively.

FIGS. 2a(1) through 2d(2) display the temporal evolution of VOC components characterized in Examples 2a through 2d at three sampling locations along the height of the Test Stripper: namely SP1, SP2 and SP3. The concentration of the first VOC component (2-methylpentane) and the second VOC component (1-octene) are denoted as C₁ and C₂, respectively.

FIGS. 3a(1) through 3f(2) display the temporal evolution of VOC components characterized in Examples 3a through 3f at three sampling locations along the height of the Test Stripper: namely SP1, SP2 and SP3. The concentration of the first VOC component (2-methylpentane) and the second VOC component (1-octene) are denoted as C₁ and C₂, respectively.

FIG. 4 shows the final heating thermograms of an ethylene/α-olefin copolymer sample quenched from melt to −40° C. or quenched from melt to an annealing temperature of 50° C. and kept isothermal at different annealing times and then quenched to −40° C.

FIG. 5 shows the evolution of elastic modulus (G′) and damping factor (tan δ) at a frequency of 70 rad/s for an ethylene/α-olefin copolymer sample during isothermal annealing at 50° C.

### DEFINITION OF TERMS

Other than in the examples or where otherwise indicated, all numbers or expressions referring to quantities of ingredients, etc., used in the specification and claims are to be understood as modified in all instances by the term “about”. Accordingly, unless indicated to the contrary, the numerical parameters set forth in the following specification and attached claims are approximations that can vary depending upon the desired properties that the various embodiments desire to obtain. At the very least, and not as an attempt to limit the application of the doctrine of equivalents to the scope of the claims, each numerical parameter should at least be construed in light of the number of reported significant digits and by applying ordinary rounding techniques. The numerical values set forth in the specific examples are reported as precisely as possible. Any numerical values, however, inherently contain certain errors necessarily resulting from the standard deviation found in their respective testing measurements.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

In order to form a more complete understanding of this disclosure the following terms are defined and should be used with the accompanying figures and the description of the various embodiments throughout.

As used herein, the term “monomer” refers to a small molecule that may chemically react and become chemically bonded with itself or other monomers to form a polymer.

As used herein, the term “α-olefin” is used to describe a monomer having a linear hydrocarbon chain containing from 3 to 20 carbon atoms having a double bond at one end of the chain; an equivalent term is “linear α-olefin”.

As used herein, the term “ethylene/α-olefin copolymer”, refers to macromolecules produced from ethylene monomers and one or more additional monomers where the one or more additional monomers are α-olefins; regardless of the specific catalyst or specific process used to make the ethylene/α-olefin copolymer.

As used herein, the term “pellet” is used in distinction from non-pelletized polymeric solids that are typically referred to by persons skilled in the art as “granules” or “powders”.

### DESCRIPTION OF EMBODIMENTS

The present disclosure relates to the devolatilization treatment of the ethylene/α-olefin copolymer pellets to a target residual volatile hydrocarbons level. The following is an overview of typical operations to convert a solution containing an ethylene/α-olefin copolymer (i.e., where the solution is produced by a solution-polymerization process) to ethylene/α-olefin copolymer pellets and a multi-step process for devolatilization of the resulting ethylene/α-olefin copolymer pellets to a target residual volatile hydrocarbons level.

### Solution Polymerization Process

Descriptions of a typical solution polymerization process for the preparation of ethylene/α-olefin copolymers are provided in U.S. Pat. No. 9,512,282 ('282 patent); U.S. Pat. Nos. 6,063,879; 6,878,658; and U.S. Pat. No. 10,995,166 (Kazemi et al.). Typical comonomers include 1-butene; 1-hexene; 1-octene (and mixtures thereof). The solvent is typically a mixture of C₆ to C₁₀ alkanes and iso alkanes and may also include cyclic hydrocarbon (such as cyclopentane or cyclohexene).

The description in the '282 patent and Kazemi et al. include a review of some suitable/typical reactor configurations; catalyst deactivation systems and polymer recovery systems that include one or more vapor/liquid (V/L) separations. The output from the final V/L separator includes a molten polymer stream that contains the ethylene/α-olefin copolymer together with residual hydrocarbons (especially residual solvent and residual α-olefin comonomer). This molten polymer stream is typically directed through an extruder having a die plate at the extruder exit. The die plate is typically configured with a plurality of circular holes, thereby leading to the formation of “spaghetti strands” of extrudate. These strands are continuously cut by one or more rotating die plate cutters (which are also referred to as “knives” by those skilled in the art) to form the pellets. In some pelletizing operations, a melt pump (also referred to as a gear pump) may be located between the exit of the extruder and the die plate to generate additional pressure without causing overheating. In general, lower melt temperatures are preferable over higher melt temperatures to avoid degradation of the polymer.

The die plate cutters may be water cooled. In general, a lower die plate temperature is used for ethylene/α-olefin copolymers with lower densities (in comparison to the die plate temperature used for higher density ethylene/α-olefin copolymers) because of the stickiness of this compositions, particularly in the case of ethylene/α-olefin copolymers with a density less than 0.905 g/cm³. The pellets are conveyed away from the die plate using water and this water may be chilled or, alternatively, heated (as discussed, below). It is known to those skilled in the art that higher water temperatures are typically used for higher density/higher crystallinity polymers (in comparison to the water temperature used for lower density ethylene/α-olefin copolymers). Additives may be incorporated into the “cutter water” to mitigate foaming and stickiness problems and the use of these additives is known to those skilled in the art.

The conventional water conveying system described above (i.e., a slurry of pellets in water being transferred through tubes) is used to move the pellets to the devolatilization operations/finishing operations.

Heating the pellets to the devolatilization temperature using a gas stream would take a long time. It is thus preferred to pre-heat pellets by the slurry water stream to a temperature close to the desired devolatilization temperature to facilitate the subsequent devolatilization step.

In an embodiment of this disclosure, the slurry water may be at a higher temperature than the water used to chill the die plate and may be used to heat the ethylene/α-olefin copolymer pellets. In an embodiment of the disclosure, the slurry water may heat the ethylene/α-olefin copolymer pellets to a temperature less than or equal to the VICAT softening temperature of the ethylene/α-olefin copolymer measured according to ASTM D1525-17.

In another embodiment of the disclosure, the slurry water may be used to heat (or alternatively, cool) the ethylene/α-olefin copolymer pellets to a temperature that is at least about 5° C. lower than the VICAT softening temperature of the ethylene/α-olefin copolymer.

### Spin Dryer

Water may be removed from the slurry using a conventional spin dryer. After spin drying, the pellets will typically contain about 0.05 weight % water. Air may be used to further reduce the water content. Drying the pellets prior to the devolatilization step is preferred so as to prevent reduction in pellets temperature resulting from water evaporation at the devolatilization temperature. The water that is removed in the spin dryer may be returned to the die plate cutter for reuse/recycle.

### Transfer of Dry Pellets to Devolatilization Bins

The “dry” ethylene/α-olefin copolymer pellets are then directed to a hold up bin that is preferably purged with nitrogen. The pellets are then conveyed to a devolatilization bin. In an embodiment, this conveyance is undertaken using a flow of nitrogen (and, in an embodiment, this nitrogen is “recycled” from a nitrogen purification system).

The temperature of the nitrogen used for this conveyance should also be controlled. In an embodiment, this temperature is less than or equal to 5° C. lower than the VICAT softening temperature of the ethylene/α-olefin copolymer to prevent formation of adhesive contacts between pellets.

### Devolatilization Bins

In an embodiment, the devolatilization bin holds from about 150 to about 200 thousand kilograms of the ethylene/α-olefin interpolymer pellets and have a hold up time of from about 12 hours to about 72 hours. Thus, for a typical commercial-scale plant, multiple bins will be required.

In an embodiment, the devolatilization bin has a conventional silo shape—i.e., a simple bin having a circular cross-sectional shape. In an embodiment, the height/diameter ratio is from 3/1 to 8/1, especially from 4/1 to 5/1. In an embodiment, a cone is fitted at the bottom of the silo. The cone portion of the silo can be further broken into separate compartments to minimize the consolidation pressure experienced by pellets in that location of the silo.

In an embodiment, the devolatilization bin is operated under vacuum to improve the rate of devolatilization. In a different, alternative embodiment, the bin is operated under a small positive pressure to limit ingress of air.

In an embodiment, the positive pressure is from 102 to 109 kPa. Operating at pressures slightly above atmospheric pressure is preferred. Low-pressure bin operation can be costly due to vacuum requirements and high-pressure bin operation requires a significant amount of stripping agent to complete devolatilization process to the same final VOCs content in pellets. The devolatilization bin is preferably purged with nitrogen even when empty, when being filled and when being unloaded.

The devolatilization bin is loaded via nitrogen conveyance from the hold up bin. In an embodiment of the disclosure, the ethylene α-olefin copolymer pellets temperature when entering the devolatilization bin is at least 5° C. lower than the VICAT softening temperature of the ethylene/α-olefin copolymer

The devolatilization bin is filled with the ethylene/α-olefin copolymer pellets at a filling time t_{f}. The filling time t_{f} varies from greater than or equal to 0.5 hour to less than or equal to 5 hours. In an embodiment, the filling time t_{f} varies from greater than or equal to 1 hour to less than or equal to 4 hours. The ethylene/α-olefin copolymer pellets are characterized by containing greater than or equal to 1 weight % of residual volatile hydrocarbons to less than or equal to 5 weight % residual volatile hydrocarbons when entering the devolatilization bin. In an embodiment, the ethylene/α-olefin copolymer pellets contain from about 2 to 4 weight % residual volatile hydrocarbons when entering the devolatilization bin.

In an embodiment, the devolatilization bin is insulated. In an embodiment, the devolatilization bin is equipped with heat tracing to compensate for heat loss in cold weather. In an embodiment, the exterior of the devolatilization bin is equipped with a system to apply cooling water in hot weather—e.g., a simple water spray may be applied to the exterior.

### Nitrogen Supply to Devolatilization Bins

In the present disclosure, nitrogen gas is provided to the devolatilization bin at a first nitrogen inlet temperature (T_{N}^{inlet})¹ for a first period of time t₁ subsequent to the filling time t_{f}, wherein the first nitrogen inlet temperature (T_{N}^{inlet})¹ is influenced by the VICAT softening temperature of the ethylene/α-olefin copolymer that is being treated. To be specific, the first nitrogen inlet temperature (T_{N}^{inlet})¹ is greater than VSP−30° C. and less than the VSP of the ethylene/α-olefin copolymer. In an embodiment, the first nitrogen inlet temperature (T_{N}^{inlet})¹ may be greater than VSP−15° C. and less than or equal to VSP−5° C. of the ethylene/α-olefin copolymer. In an embodiment, the first nitrogen inlet temperature (T_{N}^{inlet})¹ may be greater than or equal to 40° C. and less than or equal to 85° C., or greater than or equal to 40° C. and less than or equal to 70° C.

The first period of time t₁ is sufficient to form a new peak melting temperature Tₘ¹ in the ethylene/α-olefin copolymer, wherein Tₘ¹ is greater than (T_{N}^{inlet})¹ and less than a highest peak melting temperature Tₘ of the ethylene/α-olefin copolymer. In an embodiment of this disclosure, the new melting peak Tₘ¹ is from 5 to 15° C. above the first nitrogen inlet temperature (T_{N}^{inlet})¹, or from 5 to 10° C. above the first nitrogen inlet temperature (T_{N}^{inlet})¹.

In a second period of time t₂ subsequent to the first period of time t₁, the nitrogen gas temperature provided to the devolatilization bin is raised and held at a second nitrogen inlet temperature (T_{N}^{inlet})². The second nitrogen inlet temperature (T_{N}^{inlet})² is greater than (T_{N}^{inlet})¹ and less than Tₘ¹. In an embodiment of this disclosure, the second nitrogen inlet temperature (T_{N}^{inlet})² is (T_{N}^{inlet})¹+5° C.

The ethylene/α-olefin copolymer pellets are discharged from the devolatilization bin at a third period of time t₃ subsequent to the second period of time t₂.

In an embodiment, the devolatilization bin is purged during the filling time t_{f} with the nitrogen gas having a temperature equal to the first nitrogen inlet temperature (T_{N}^{inlet})¹. In an embodiment, the devolatilization bin is purged during the third period of time t₃ with the nitrogen gas having a temperature equal to the second nitrogen inlet temperature (T_{N}^{inlet})². In an embodiment, the ethylene/α-olefin copolymer pellets, when entering the devolatilization bin, are pre-heated to a temperature equal to the first nitrogen inlet temperature (T_{N}^{inlet})¹.

In an embodiment, the level of residual volatile hydrocarbons (or volatile organic compounds, VOCs) will be reduced to below 500 ppm, especially below 300 ppm, and most especially below 150 ppm after a holdup time (HUT) corresponding to sum of the filling time, the first period of time t₁, the second period of time t₂ and the third period of time t₃. Lower levels of VOCs may be achieved at a greater cost using longer hold up times (e.g., by extending any or all of the above-specified period of times) and/or flow rate of nitrogen provided to the devolatilization bin.

The devolatilization operation is performed in batch mode—i.e., the devolatilization bin is emptied/readied for reuse once the ethylene/α-olefin copolymer pellets are devolatilized to the target VOC level.

In an embodiment, the flow rate and velocity of the nitrogen provided to the devolatilization bin is not high enough to develop a fully fluidized bed—the advantages of avoiding a fully fluidized bed are known to those skilled in the art and are described in U.S. Pat. No. 5,478,922 (Rhee, to UCC).

In an embodiment, the first period of time is sufficient to increase elastic modulus of the ethylene/α-olefin copolymer by at least 15%. In an embodiment, the increase in the elastic modulus is accompanied a decrease in the damping factor.

In an embodiment, the devolatilization bin has a top end wall and a bottom end wall, and a continuous sidewall therebetween, wherein the nitrogen gas is continuously provided to a first area proximal the bottom end wall using a plurality of feed nozzles as an upward flow to the devolatilization bin at a mass flow rate from 2-15 weight % or from 2-10 weight % or from 4-10 weight % per hour, based on the total weight of ethylene/α-olefin copolymer pellets in the devolatilization bin. To be specific, for example, a devolatilization bin that contains 200 tons of ethylene/α-olefin copolymer pellets can be provided with a nitrogen mass flow rate of 10 tons per hour to provide a nitrogen flow rate of 5 weight % per hour, based on the total weight of ethylene/α-olefin copolymer pellets in the devolatilization bin.

In an embodiment, during any or both of the first and second periods of time, an amount of the ethylene/α-olefin copolymer pellets is periodically recirculated from a second area proximal to the bottom end wall of the devolatilization bin to a third area proximal to the top end wall of the devolatilization bin. In the case of ethylene/α-olefin copolymers having a density from 0.865 to 0.900 g/cm³, devolatilized in larger bin sizes, this recirculation step can be helpful in preventing pellets near the bottom end wall from forming agglomerates leading to clumping and blocking the devolatilization bin. Pellets near the bottom end wall of the devolatilization bin experience a larger consolidation pressure and are more prone to clumping.

This pellets recirculation step is done by directing the ethylene/α-olefin copolymer pellets from the second area proximal to the bottom end wall of the devolatilization bin to the third area proximal to the top end wall of the devolatilization bin through a first opening positioned adjacent the second area proximal to the bottom end wall of the devolatilization bin and a conveying means external to the devolatilization bin extending from the first opening to a second opening positioned adjacent the third area proximal to the top end wall of the devolatilization bin. In an embodiment, the conveying means may be a pneumatic conveying means which uses nitrogen gas as motive gas.

In an embodiment, the amount of pellets that is transferred is from about 0.5 to 5 weight % of the total weight of ethylene/α-olefin copolymer pellets. The recirculation rate is preferred to be kept to an optimum value to minimize the adverse impact of recirculation on overall devolatilization hold up time. In an embodiment, the ethylene/α-olefin copolymer pellets are recirculated over a recirculation time of 10 minutes at least every 8 hours for the ethylene/α-olefin copolymer density range from 0.865 to 0.885 g/cm³ or at least every 16 hours for the ethylene/α-olefin copolymer density range from 0.885 to 0.900 g/cm³.

The fluid at the top of the bins is a mixture of nitrogen and volatile hydrocarbon that has been stripped from the pellets. This fluid may be referred to as “mixed stripper gas” and can optionally be directed to a nitrogen purification system for the removal of hydrocarbons. Technologies such as adsorption, absorption, condensation, cryogenic distillation, and membrane separation are generally suitable for the removal of volatile hydrocarbons (which may also be referred to as volatile organic compounds, or “VOCs” by those skilled in the art) from the mixed stripper gas for reuse/recycle.

### Testing Methods

Prior to testing, each specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Ethylene/α-olefin copolymer density in the solid state was determined using ASTM D792-13 (Nov. 1, 2013).

### Melt Index

Ethylene/α-olefin copolymer melt index was determined using ASTM D1238 (Aug. 1, 2013). Melt indexes, 12 was measured at 190° C., using a weight of 2.16 kg.

### VICAT Softening Temperature

Ethylene/α-olefin copolymer VIACT softening temperature was measured using ASTM 1525-17 (Aug. 1, 2017) under a load of 10±0.2 N and at a heating rate of 120±10° C./h. Initial temperature of heat transfer medium (DOW Corning 710) was 20-23° C. In the present disclosure, unless indicated to the contrary, the VICAT softening temperature measurements were performed on compression molded specimens molded at 165° C. and quenched at a cooling rate of about 50° C. per minute to a temperature of about 10° C.

### Differential Scanning Calorimetry (DSC)

Differential Scanning Calorimetry was utilized to determine the peak melting temperature Tₘ for the ethylene/α-olefin copolymers during a second heating cycle. The DSC instrument (TA Instruments Q2000 equipped with a Refrigerated Cooling System) was first calibrated with indium; after the calibration, an ethylene/α-olefin copolymer specimen was equilibrated at 0° C. and then the temperature was increased to 140° C. at a heating rate of 10° C./min; the melt was then kept isothermally at 140° C. for ten minutes; the melt was then quenched to −40° C. at a cooling rate 50° C./min and kept at −40° C. for ten minutes; the specimen was then heated to 200° C. at a heating rate of 10° C./min. The highest peak melting temperature Tₘ was determined according to a peak melting temperature with the highest temperature observed for the quenched sample within a temperature range of less than or equal to 100° C. during the second-heating cycle after quenching from melt to −40° C.—e.g., if multiple peak melting temperatures (i.e., multiple local minima) are observed within this range, Tₘ is the one with the highest temperature.

A series of DSC annealing heat treatment experiments were performed by equilibrating the ethylene/α-olefin copolymer specimen at 0° C. and then increasing the temperature to 140° C. at a heating rate of 10° C./min; the melt was then kept isothermally at 140° C. for ten minutes; the melt was then quenched to a prescribed annealing temperature at a cooling rate of 50° C./min; isothermal condition was maintained for an annealing time of 0.5, 1, 2 or 24 hours; the specimen was then quenched to −40° C. at a cooling rate 50° C./min and kept at −40° C. for ten minutes; the specimen was then heated to 200° C. at a heating rate of 10° C./min to capture the 2nd heating thermogram.

### Volatile Organic Compounds (VOCs) Concentration

Concentration of volatile organic compounds (VOCs) in the raw pellets of ethylene/α-olefin copolymers (i.e., after pelletization and before entering the devolatilization bin), during devolatilization and in the devolatilized pellets may be measured by techniques well-known to those of ordinary experience. In the present disclosure, an accurate measurement of VOC was applied using headspace gas chromatography (HS-GC/FID) performed by a full evaporation technique (FET) to quantify VOCs content within a range from 50 ppm to 5 weight %.

In this technique, a small number of pellets (about 4-6 pellets having a weight from 80 to 120 mg) is loaded in a tared 20 ml glass headspace vial. The weight of pellets was recorded, and the vial was sealed with Teflon rubber septa (Teflon side down) and aluminum seal using crimpers. The sealed vial was then loaded for analysis. A person of ordinary skill in the art is cognizant of the fact that the large ratio of headspace volume to sample volume substantiate the assumption that the analytes have been fully volatilized into the headspace and thus sampling the headspace is a direct measure of the total and individual content of VOC components. TABLE 1 displays the conditions for the autosampler and the GC measurements that were followed to quantify VOCs content in pellets sampled from different temporal and spatial points during the devolatilization process.

Calibration curves for the FET method were developed by preparing standards according to the following steps:
The stock standard had a target concentration of 200-250 ppm by weight of 2-methyl pentane/hexane and 150-200 ppm by weight of octene. The dilute standard was ten folds less concentrated. The diluent for standards was cyclohexane.
Weighing of the components was done quickly and with care to minimize losses due to their highly volatile nature. After each addition, the flask was tightly sealed and weighed promptly. The standard preparation was re-started if drifts in weight were continually observed.
Small aliquots of the solutions were added to sealed and tared headspace vials. Vials were weighted after addition of the aliquots. The calibrations consisted of 3-5 points using each solution. From the stock, between 4-12 μL were added. This corresponded to approximately 3 to 10 mg. From the dilute standard, vials were prepared by adding 5-30 μL of the solution having an approximate weight range of 4-25 mg.

TABLE 1
FET Headspace-GC/FID Method Conditions for Calibration and Testing

| Autosampler | | | GC | | |
|---|---|---|---|---|---|
| Oven Temperature | 180° | C. | Column | DB, HP, ZB-5. | |
| | | | | 30 m/0.25 mm/1 μm | |
| Loop/Valve Temperature | 190° | C. | Injector Temp. | 275° | C. |
| Transfer Line Temperature | 200° | C. | Carrier | UHP Helium | |
| GC Cycle Time | 35 | minutes | Gas Velocity | 29 | cm/sec |
| Vial Equilibration Time | 15 | minutes | Split Ratio | 20:01 | |
| Pressure Equilibration | 0.25 | minutes | Mode | Constant Flow | |
| Time | | | | | |
| Injection Time | 2.00 | minutes | Temperature | 4 minutes at 50° C. | |
| Fill Mode | Flow to | | Program | 20° C./minute to 300° C. | |
| | pressure | | | Hold 10 minutes | |
| Fill Pressure | 10 | psi | | | |
| Fill Flow | 6 | psi | | | |
| Loop Fill Mode | Default | | | | |
| Loop Fill Ramp Rate | 20 | | | | |
| Loop Final Pressure | 12.55 | psi | | | |
| Vent After | Yes | | | | |
| Nominal Vial Size | 20 | ml | | | |

| | |
|---|---|
| Shaking/Mixing | No |

### Diffusion Coefficient of VOCs in the Ethylene/α-Olefin Copolymer

Diffusion coefficient of each VOC component in the ethylene/α-olefin copolymer was determined by modifying an HP 5890 GC to allow for the monitoring of hydrocarbon present in a nitrogen flow used to strip the ethylene/α-olefin copolymer pellets. This was achieved by replacing the column in the GC oven with a cylindrical sample holder having a diameter of 0.0127 m and a length of 0.02 m. Outside of the oven, a “T” connection with flow controller, set to 25 mL/min, was added to the nitrogen line to provide the gas flow for the experiments. Once the nitrogen carrier gas, upon into the oven, was passed through a series of coils allowing equilibration to the set oven temperature (40-90° C.). A vessel, equipped with dip tube, was added to the nitrogen feed such that moisture could be supplied to the carrier gas if desired. A temperature probe was placed after the vessel to ensure that the carrier gas is at equilibrium with the oven temperature. The nitrogen feed was pipped to a 3-way valve either directing the flow through the sample holder or through a bypass pipping. A second 3-way valve was added to direct the carrier gas flow out of the oven to the FID detector.

Prior to the analysis, the ethylene/α-olefin copolymer pellets were dried in a Schlenk flask (having a volume of 250 or 500 mL) which was capped with a rubber septum and was placed under vacuum using a Schlenk line with trap at a final vacuum of 20-50 mtorr. A liquid N₂ trap was used during working hours and dry ice/ethanol trap was used for overnight use. The flask was heated to a temperature below the VICAT softening temperature of the bulk polymer determined according to ASTM D1525, particularly from 1° C. to 20° C. below the VICAT softening temperature of the bulk polymer, for a duration of time ranging from 5 hours to 66 hours. After drying, the flask was transferred to a glovebox and kept sealed in a VWR wide-mouth PE 500 mL bottle until used.

Samples were prepared by weighing 1 g of dried ethylene/α-olefin copolymer pellets and then either soaking them or injecting them with the VOC component(s) of interest. The cumulative mass of the pellets and the VOC component(s) was then recorded, and the sample was allowed to equilibrate for roughly 20-24 hours. The next step in preparing the experiment after the 20-24 hours equilibration period was to ensure that the valves were orientated such that the carrier gas flowed through the bypass piping. Next the sample holder was loaded into the GC using wrenches. The oven temperature was then set for the run and turned on.

Once the GC was ready, the run was started using the control window. Approximately 5 minutes of baseline was collected before the valves flipped to allow flow through the sample holder. The collection time maximum for the GC used in the present disclosure is 650 minutes, which was not enough time to collect the entire decay curves. Therefore, at the end (or close to end) of the 650 minutes run, the run was stopped with the control window. The software automatically downloaded a new file with a Cycle Number set to 2. Once ready, a second run was started using the control window, and data collection was continued. At the end of second cycle, the oven was turned off and the valves switched back to the bypass piping. The sample holder would be removed from the GC oven and capped. Once cool, the sample holder was weighed, and the final mass of the ethylene/α-olefin copolymer pellets was back calculated using the recorded tare weight of the holder and caps.

The obtained FID response in mV (millivolt) was scaled with respect to the baseline and then normalized with respect to the total area under the FID response curve. A time offset correction was applied to account for the initial lag in the response due to the distance between the sample and detector location. The diffusion coefficient of the VOC component in the ethylene/α-olefin copolymer was determined at the applied test temperature by fitting a normalized version of the Crank's spherical diffusion model (e.g., normalized mass loss Mₜ/M_{∞}, as the VOC component leaves the polymer sample; a form similar to the equation 6.20 of Crank, John. The mathematics of diffusion. Oxford university press, 1979) to the normalized FID response curve using a MATLAB code.

A constant diffusion coefficient was assumed for the fitting of the diffusion model. This assumption was only valid for the portion of data where changes in total mass (Mₜ/M_{∞}) is a linear function of time. At very low VOC concentrations, at the end of experiment, experimental mass loss results may, to some extent, deviate from the fitted diffusion model. This is due to the fact that, at low VOC concentrations, the diffusion coefficient becomes concentration dependent. However, the amount of deviation was not significant and occurred at very VOC concentrations (below 20 ppm), and the assumption of constant diffusion coefficient was still capable of satisfactorily representing the mass loss curves.

### Desorption Isotherms for Pellets—VOCs System

The mass transfer rate of each VOC component between the ethylene/α-olefin copolymer pellets and surrounding vapor gas phase was determined for each VOC component using a GC head space analysis developed to accurately measure the desorption isotherms. Given the nonpolar nature of the components and the low concentrations of VOCs considered in the present disclosure, the desorption isotherms were observed to closely follow a linear form—i.e., the partial pressure of the VOC component in the boundary layer varied linearly with the concentration of that VOC component at the surface of pellets.

Prior to the analysis, the ethylene/α-olefin copolymer pellets were dried in a Schlenk flask (having a volume of 250 or 500 mL) which was capped with a rubber septum and was placed under vacuum using a Schlenk line with trap at a final vacuum of 20-50 mtorr. A liquid N2 trap was used during working hours and dry ice/ethanol trap was used for overnight use. The flask was heated to a temperature below the VICAT softening temperature of the bulk polymer determined according to ASTM D1525, particularly from 1° C. to 20° C. below the VICAT softening temperature of the bulk polymer, for a duration of time ranging from 5 hours to 66 hours. After drying, the flask was transferred to a glovebox and kept sealed in a VWR wide-mouth PE 500 mL bottle until used.

Headspace vials (20 mL) were loaded with approximately 5 g of the dried ethylene/α-olefin copolymer pellets in a glovebox. The designated VOC(s) was/were injected into the vial using a micro-syringe at a volume ranging from 1 to 100 μL. The vial was then capped immediately with the temperature and glove box pressure recorded. Sample vial cap was inspected for a secure seal and re-crimped if necessary, before removing from the glove box. Sample was placed in an oven at the designated experimental temperature for 16-24 h to equilibrate. Experiments were performed using an Agilent GC 6890, equipped with Agilent 7697A HDSP Autosampler and FID.

Although the ethylene/α-olefin copolymer pellets were dried before being brought into the glovebox, there could be VOCs present within sample's atmosphere which could reabsorbed into the pellets. Therefore, two pellets of the ethylene/α-olefin copolymer (˜0.05 mg) were loaded into a headspace vial and characterized for the FET analysis according to the procedure described under the subheading of Volatile Organic Compounds (VOCs) Concentration in the Test Method section, providing the content of VOCs within the pellets prior to the injection of the designated VOC(s). Furthermore, an empty headspace vial was analyzed as a blank with each set of resin, so as to identify the amount of VOCs present within the glove box atmosphere at the time of sample preparation. The blank and FET sample were always the last two samples to be capped. Calibration curves were used to quantify the GC results and convert the obtained area count for each VOC component into the partial pressure of the VOC component in headspace based on the VOC concentration in headspace at the test temperature by applying the ideal gas law. For the purpose of this conversion, a headspace volume of 21.8278 mL was considered (including the volume of the neck). The obtained VOC partial pressures in headspace (in kPa) were plotted as a function of VOC present in the pellets sample (in kg VOC/kg resin). The plotted results showed a strong linearity at low VOC concentrations. A model was developed to describe the correlation between isotherm slope and the resin's melt index and density and the test temperature.

### Rheological Response Under Small-Amplitude Oscillatory Shear

Small-amplitude oscillatory shear measurements were performed under an N₂ atmosphere using a MCR501 rotational rheometer with a 25 mm stainless steel parallel-plate geometry according to procedure that follows. These experiments were intended to monitor the evolution of rheological response during a cooling cycle from melt and more specifically at an annealing temperature well below the melting temperature of the ethylene/α-olefin copolymer. The MCR501 rotational rheometer was equipped with a CTD450 convection oven. A pre-compression molded disk of the ethylene/α-olefin copolymer with a thickness of about 1.9-2 mm was loaded on the rheometer lower plate at a temperature close to 140° C. After reaching thermal equilibrium at 140° C., the upper plate was lowered squeezing the molten polymer at a rate of 1000 to 100 μm/s not exceeding a normal force of 40 N. The upper plate was lowered to a vertical position 30 μm above the testing gap-height and the excess molten sample was trimmed and the gap was lowered to the testing position of 1.5 mm. The temperature was kept constant to reach thermal equilibrium at 140±0.1° C. and then lowered to the desired annealing temperature at a cooling rate of 0.5 K/min. The experiment was then continued isothermally at the annealing temperature. During this experiment, a strain-wave γ(t) prescribed as a superposition of multiple oscillation modes was applied and the resulting stress response τ(t) was analyzed in terms of elastic and loss moduli and their ratio (tan δ) as a function of angular frequency and temperature. To achieve fast data recording, the fundamental frequency was set to 1 rad/s with its 2nd, 4th, 7th, 10th, 20th, 40th, 70th harmonics. To be specific, the applied strain-wave composed of a fundamental frequency (ω_{f}) of 1 rad/s and several of its harmonics superimposed as γ(t)=Σᵢγᵢ sin(mᵢω_{f}t) where i and mᵢ∈ [symbol] and γᵢ was the strain-amplitude at the i-th frequency level. The total strain was kept well within the linear viscoelastic limits (i.e., γ_{T}=0.047) and the duration of each scan was 60 s. The obtained stress-wave was decomposed using a rheology data processing software (RHEOPLUS/32 V3.40) to obtain the individual stress-wave and viscoelastic functions at each frequency level (i.e., mᵢω_{f}s where mᵢ∈ [symbol] ).

### EXAMPLES

### Example 1: Test Stripper

In the present disclosure, a Test Stripper was constructed to feed a well-controlled stream of tempered nitrogen into a vessel and collect small pellet samples along the height of the resin bed to experimentally capture VOCs concentration variation in pellets during the devolatilization process. The Test Stripper was designed to control the temperature of the inlet nitrogen at a set temperature between 40° C. and 85° C. with an electric heater. The nitrogen flowrate was designed for flowrates ranging from 0 to 15 kg/h. The stripper vessel was designed as a non-registered vessel at an operating pressure slightly above the atmospheric pressure. To address concerns with heat losses along the vessel walls, electrical tracers were installed in two sections (top and bottom sections). Finally, an electrical tracer was installed on the stripper vent outlet piping to ensure that any hydrocarbon vapors (and potential moisture) does not condense and flow back into the stripper. Inlet piping after the nitrogen heater, stripper vessel and outlet piping were insulated to eliminate any heat losses. The Test Stripper was constructed from 8-inch std stainless steel piping (with an inside diameter of 7.981 inches). The overall total length of the vessel is approximately 13.5 feet (with the actual pellet bed height of 12 feet). Depending on the resin density and pellet size, the weight of the devolatilized resins ranged from 65 to 75 kg. At the base of the stripper vessel an 8-inch air actuated gate valve was installed to aid in the removal of resins after testing is completed. Five sampling points along with five temperature indicators were embedded inside the Test Stripper to monitor temporal variation of temperature and VOC components along the column height. The first sampling location (SP1) and the first temperature indicator were installed 381 mm above the nitrogen injection point. Sampling points SP2 through SP5 and the temperature indicators 1 through 5 were installed at 889 mm, 1803 mm, 2718 mm and 3480 mm the nitrogen injection point. The main sampling points were SP1, SP3 and SP5 and their respective temperature indicators. Sampling points SP2 and SP4 and their respective temperature indicators were installed in case any of the main sampling points/temperature indicators failed.

The nitrogen flow rate in the Test Stripper experiments was kept within a range well below the minimum fluidization flow rate. A skilled person in the art is familiar with methods to estimate the minimum fluidization superficial velocity using models such as Kunii-Levenspiel bubbling bed model (see D. Kunii and O. Levenspiel, Fluidization Engineering (Melbourne, Fla.: Robert E. Krieger Publishing Co., 1969)). For example, in the case of Example 1 in TABLE 1 (15.0 kg/h), by dividing the nitrogen flow rate by the bed cross sectional area (0.028 m²), one obtains a superficial velocity of ˜0.15 m/s which is significantly smaller than the minimum fluidization superficial velocity ˜1.7 m/s (estimated using the Kunii-Levenspiel bubbling bed model) and thus the pellets bed stayed in a non-fluidized state during the Test Stripper experiment.

In the Test Stripper experiments, the ethylene/α-olefin copolymer raw pellets were air conveyed to the Test Stripper after pelletization within a filling time of about 1 h. The raw pellets were produced by polymerizing ethylene and 1-octene in a continuous solution polymerization pilot plant, disclosed in detail in the U.S. Pat. No. 10,995,166 (Kazemi et al.), using a bridged metallocene catalyst formulation comprising a component A, diphenylmethylene (cyclopentadienyl) (2,7-di-t-butylfuorenyl) hafnium dimethyl, [(2,7tBu₂Flu)Ph₂C(Cp)HfMe₂]; a component M, methylaluminoxane (MMAO-07); a component B, trityl tetrakis(pentafluoro-phenyl)borate, and; a component P, 2,6-di-tert-butyl-4-ethylphenol. The produced ethylene/1-octene copolymer was recovered by use of a series of vapor/liquid separators and by forcing molten copolymer through a pelletizer. Prior to pelletization the ethylene/1-octene copolymer was stabilized by adding 500 ppm of IRGANOX® 1076 (a primary antioxidant) and 500 ppm of IRGAFOS® 168 (a secondary antioxidant), based on weight of the copolymer.

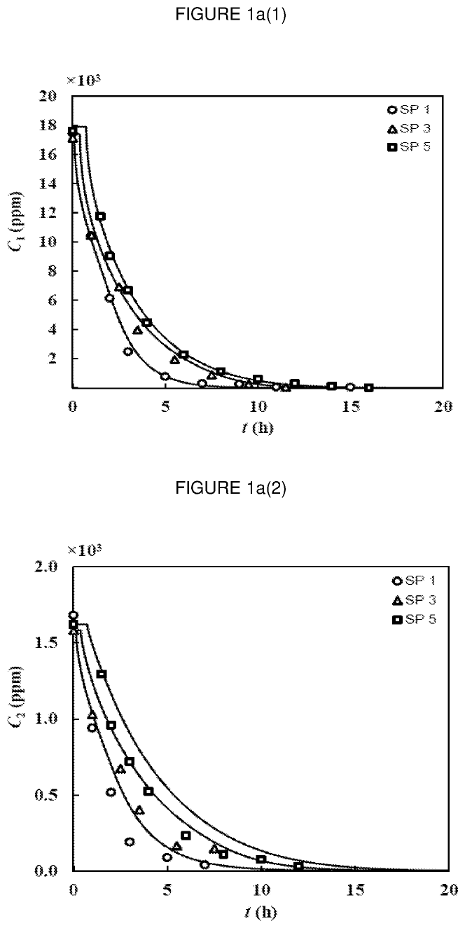

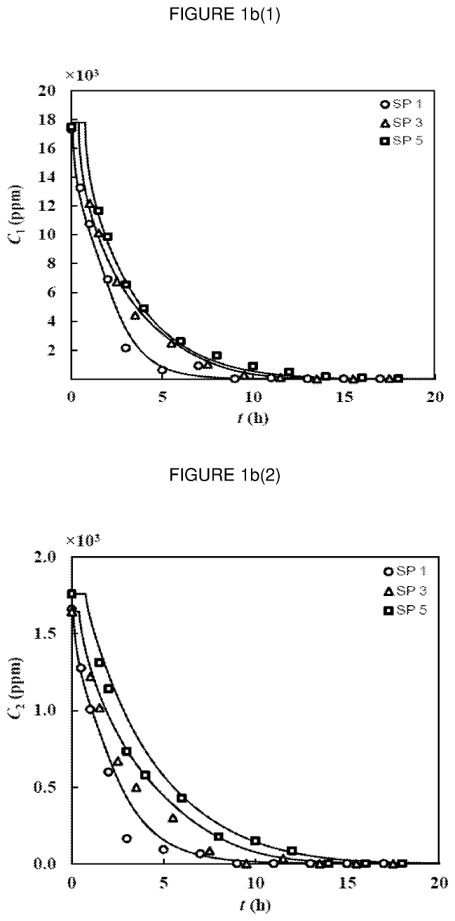

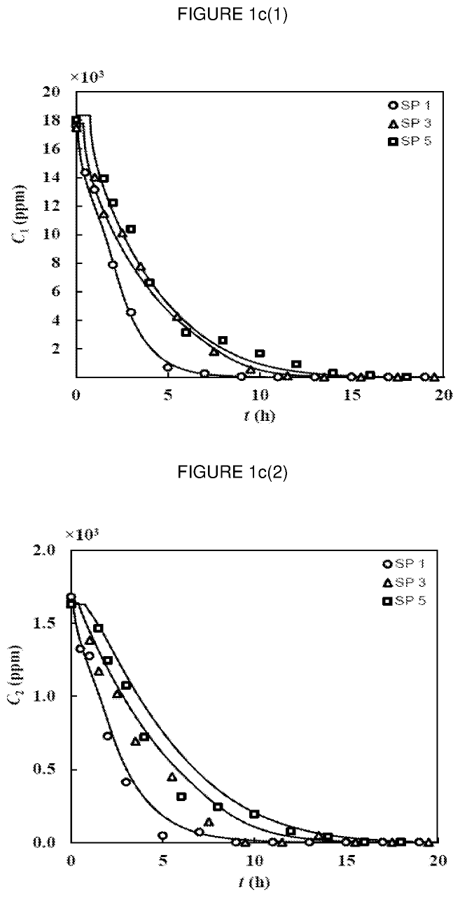

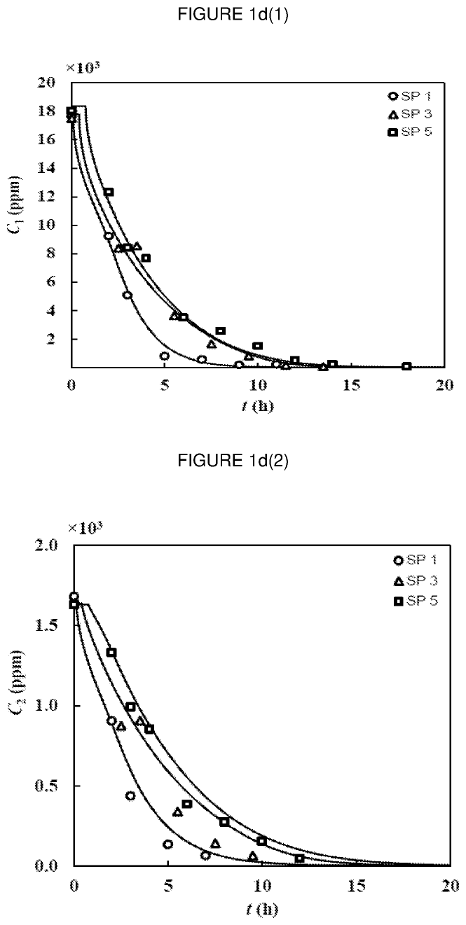

TABLE 2 summarizes the operating conditions (Examples 1 through 3) applied for the stripping tests performed using the Test Stripper. As can be seen the raw pellets contained less than 5 weight % of residual VOCs prior to the stripping experiments. All stripping experiments were performed at 5° C. below resins VICAT softening temperature for all Examples shown in TABLE 1 except Example 3f wherein stripping was performed at 10° C. below resin VICAT softening temperature. The temporal evolution of VOC components characterized in the present disclosure are shown in FIGS. 1 through 3 at three sampling locations along the height of the Test Stripper: namely SP1, SP2 and SP3. In FIGS. 1 through 3, the concentration of the first VOC component (2-methylpentane) and the second VOC component (1-octene) are denoted as C₁ and C₂, respectively. In these experiments, pellets bed void fraction was measured using gravimetric method and had a value in the range of 0.34-0.42.

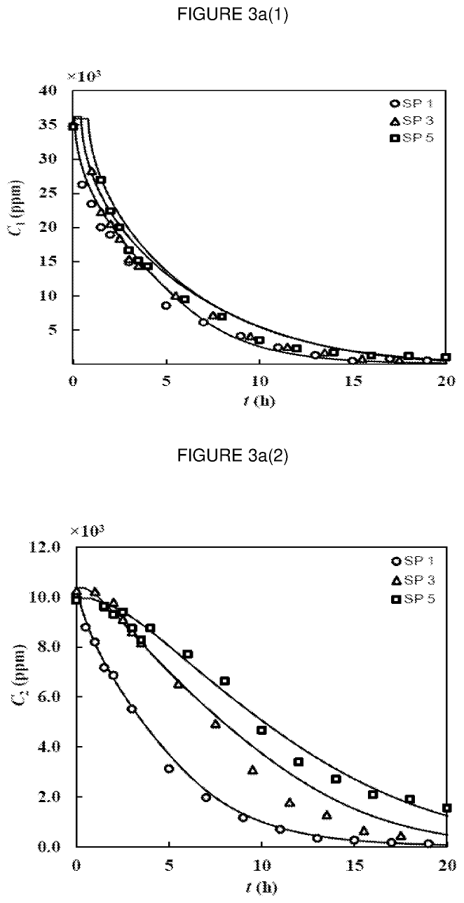

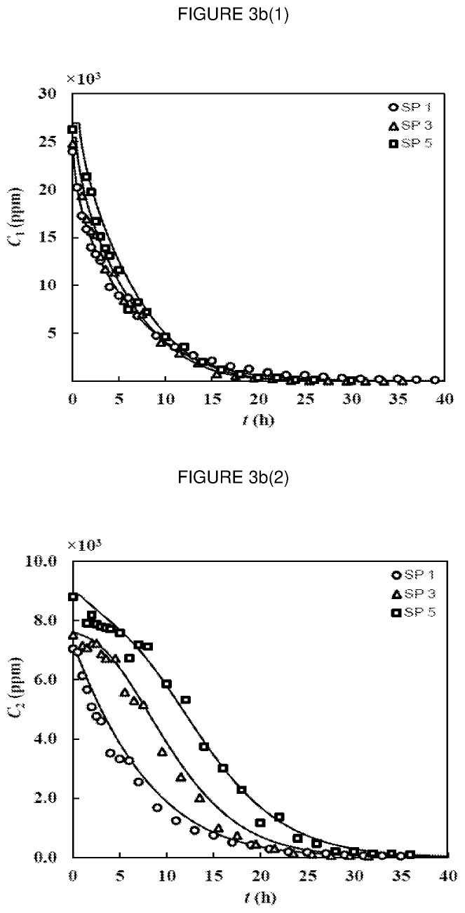

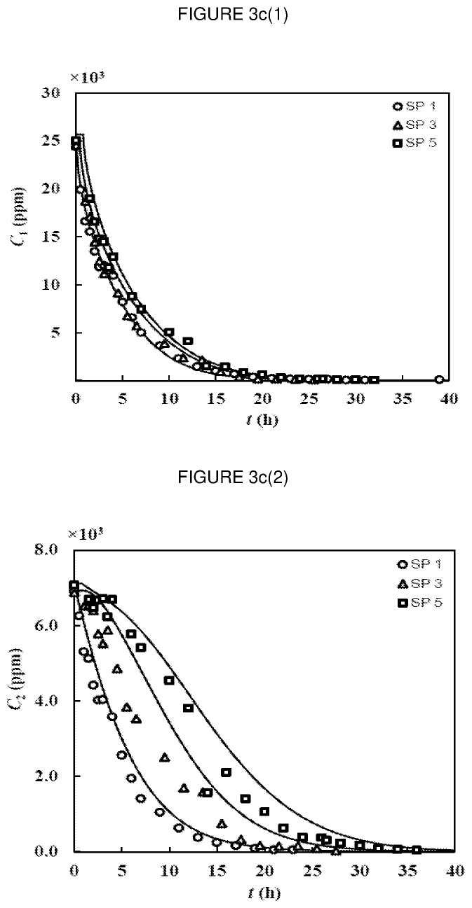

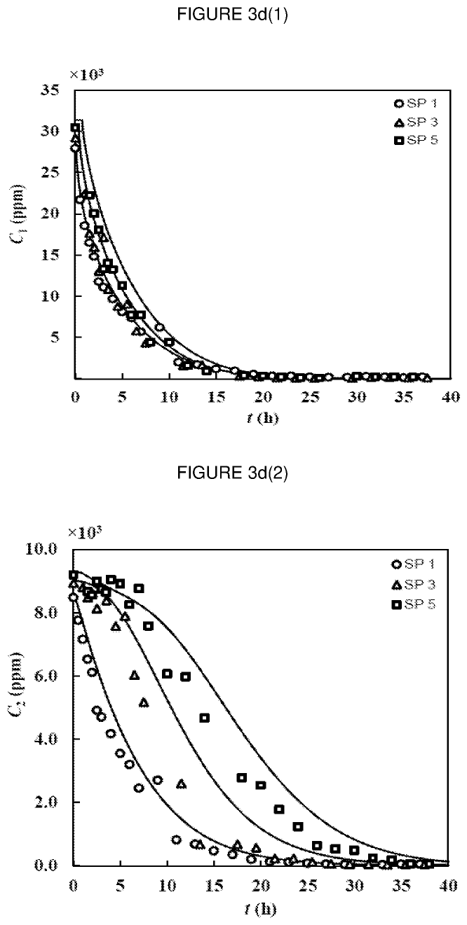

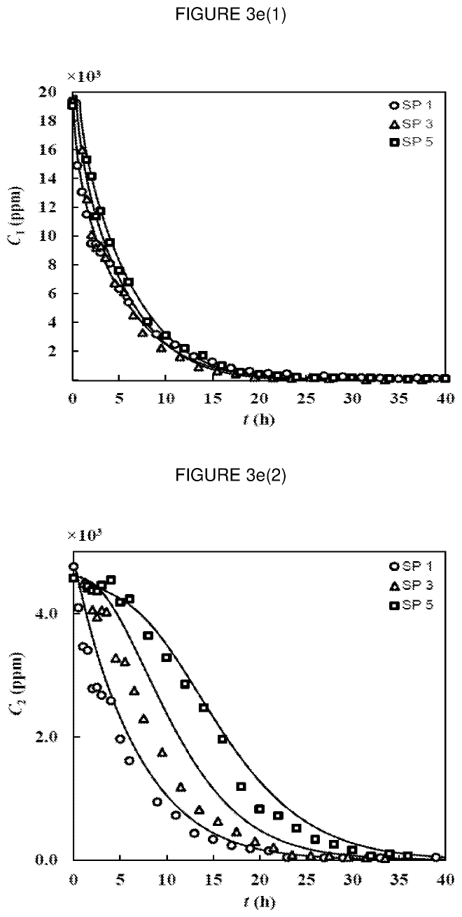

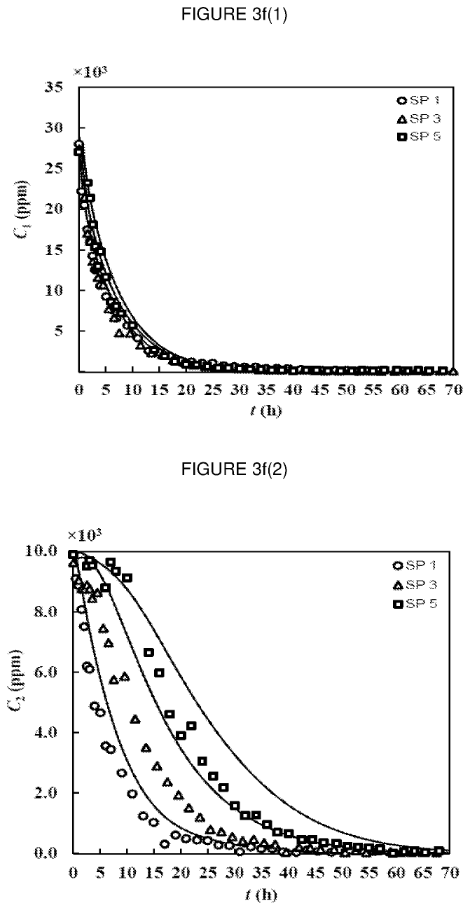

One can use these results to identify the impact of variables such as initial pellets VOCs content, initial pellets temperature, pellet size, nitrogen temperature and nitrogen flowrate on the stripping process. For example, it is observable that providing raw pellets at a temperature lower than the stripping temperature slowed down the stripping process (e.g., compare Ex. 1a and 1b with Ex. 1c). This can be interpreted in terms of nitrogen limited heat capacity leading to a slowed heating of pellets to the stripping temperature. It was further observable that initial concentration of VOCs in pellets entering the stripping area was an important factor governing the stripping time required for reaching a certain VOC level (e.g., see Ex. 3a in FIG. 3a).

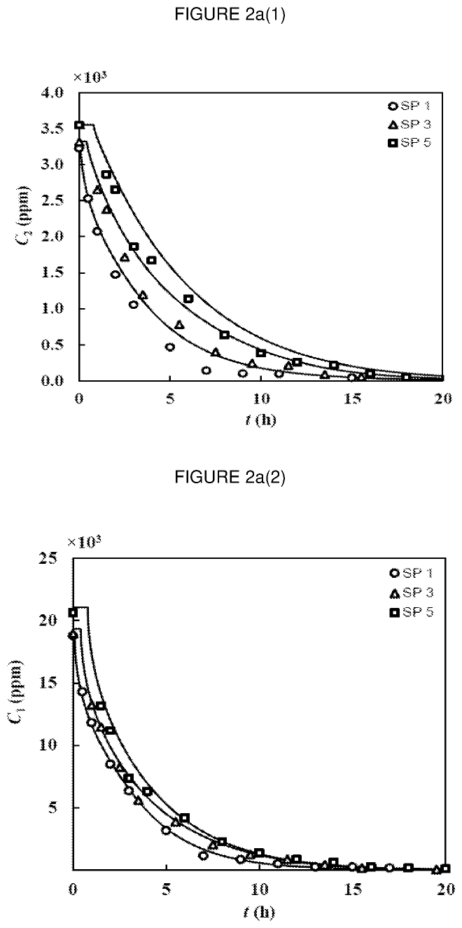

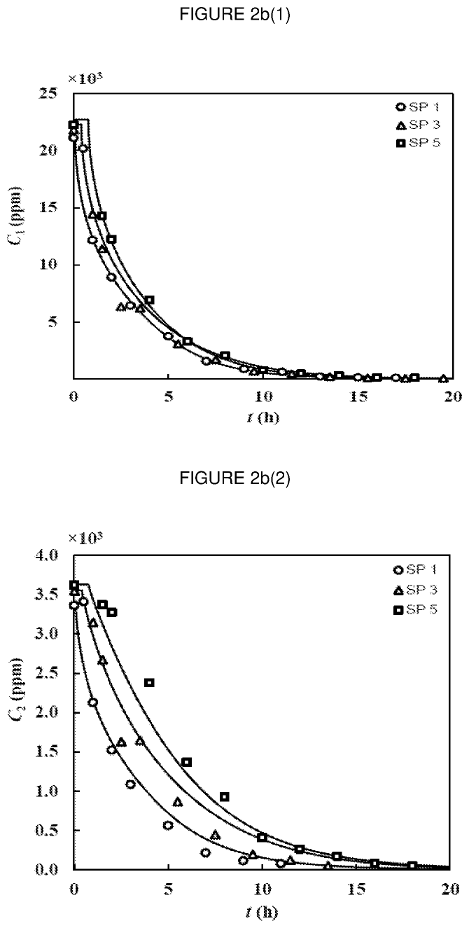

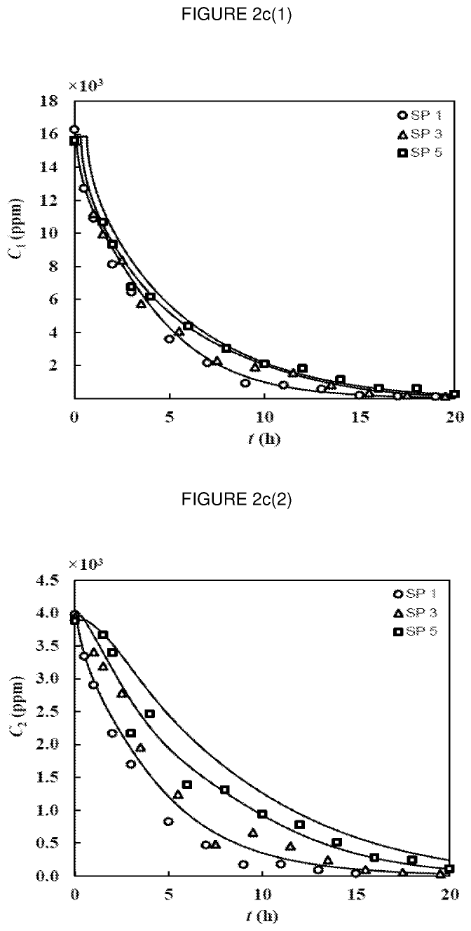

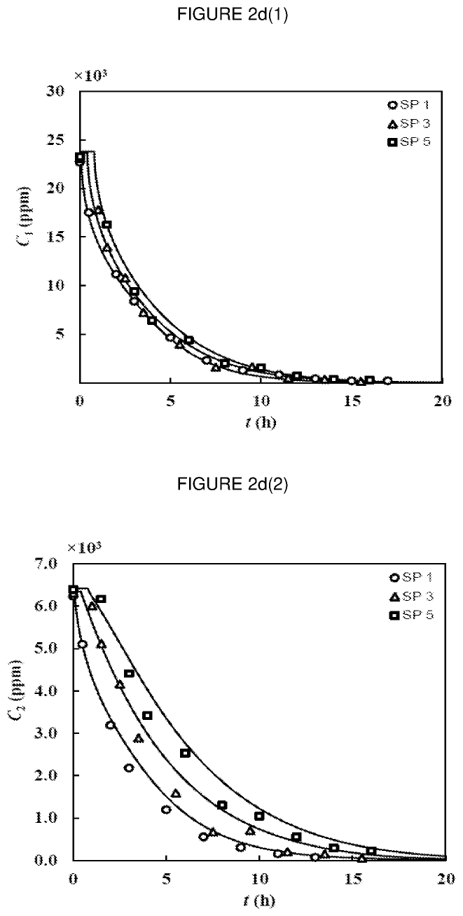

Pellet's diameter was yet another impactful factor in determining the stripping rate (i.e., the time require to reach a certain VOC concentration in FIGS. 1 through 3) of raw pellets entering the Test Stripper. As can be seen, larger pellets had a slower rate of stripping (e.g., see Examples 2c and 2d in FIGS. 2c and 2d). One can further observe a general trend in the Test Stripper experiments where more than about 80% of the VOC components were removed within the first 5 h of the stripping process. Notwithstanding this observation, reaching a target VOC concentration down to several hundred ppm can take tens of hours depending on the height location in pellets bed.

TABLE 2
Summary of the Stripping Operating Conditions
Performed Using the Test Stripper

| | | | | | Pellets | |
|---|---|---|---|---|---|---|
| | | N₂ Inlet | | | Initial | |
| | Pellet | Temper- | N₂ | Bin Top | Temper- | Total |
| | Radius | ature | Flowrate | Pressure | ature | VOC |
| | mm | ° C. | kg/h | kPa (abs) | ° C. | wt % |
| Ex. 1a | 1.9 | 80 | 15 | 126 | 55 | 1.9 |
| Ex. 1b | 1.9 | 81 | 15 | 126 | 54 | 1.9 |
| Ex. 1c | 1.9 | 82 | 15 | 126 | 30 | 1.9 |
| Ex. 1d | 2 | 81 | 15 | 126 | 31 | 1.9 |
| Ex. 2a | 2.1 | 66 | 9 | 109 | 53 | 2.3 |
| Ex. 2b | 1.9 | 66 | 9 | 109 | 49 | 2.5 |
| Ex. 2c | 2.1 | 63 | 9 | 111 | 43 | 2 |
| Ex. 2d | 1.9 | 64 | 9 | 111 | 43 | 2.9 |
| Ex. 3a | 1.9 | 52 | 9 | 110 | 28 | 4.4 |
| Ex. 3b | 2 | 40 | 4 | 103 | 17 | 3.3 |
| Ex. 3c | 2 | 40 | 6 | 103 | 40 | 3.1 |
| Ex. 3d | 1.8 | 40 | 4 | 102 | 40 | 3.8 |
| Ex. 3e | 2 | 40 | 4 | 102 | 40 | 2.4 |
| Ex. 3f | 1.9 | 40 | 4 | 102 | 40 | 3.8 |

TABLE 2
Summary of the Stripping Operating Conditions
Performed Using the Test Stripper - CONTINUED

| | Initial C₈ | | Mass of | | Resin |
|---|---|---|---|---|---|
| | Content | Initial C₆H₁₄ | Pellets | Resin MI₂ | Density |
| | wt % | wt % | kg | dg/min | g/cm³ |
| Ex. 1a | 0.2 | 1.74 | 70 | 1 | 0.906 |
| Ex. 1b | 0.2 | 1.74 | 66 | 1 | 0.905 |
| Ex. 1c | 0.2 | 1.77 | 69 | 1 | 0.906 |
| Ex. 1d | 0.2 | 1.77 | 68 | 1 | 0.905 |
| Ex. 2a | 0.3 | 1.93 | 68 | 1 | 0.896 |
| Ex. 2b | 0.4 | 2.18 | 67 | 1 | 0.896 |
| Ex. 2c | 0.4 | 1.58 | 69 | 6 | 0.895 |
| Ex. 2d | 0.6 | 2.3 | 66 | 1 | 0.895 |
| Ex. 3a | 1 | 3.41 | 64 | 1 | 0.88 |
| Ex. 3b | 0.8 | 2.48 | 69 | 2 | 0.88 |
| Ex. 3c | 0.7 | 2.45 | 71 | 2 | 0.879 |
| Ex. 3d | 0.9 | 2.92 | 69 | 1 | 0.879 |
| Ex. 3e | 0.5 | 1.91 | 70 | 1 | 0.879 |
| Ex. 3f | 1 | 2.79 | 71 | 1 | 0.881 |

### Example 2: Stripping Bin Computational Model

In the present disclosure, a computational model was generated to describe the multi-phase transport phenomena in the stripping bin process using tempered nitrogen. This model predicted the temporal and spatial variation of volatile organic compounds (VOCs) concentration. The numerical model further predicted the variation of pressure drop along the pellets bed using conservation of momentum. For further details in relation to the above-described transport phenomena, the reader can refer to Bird, R. B., Stewart, W. E., Lightfoot, E. N., & Klingenberg, D. J. (2015). Introductory transport phenomena. Wiley Global Education, Treybal, R. E. (1980). Mass transfer operations. McGraw-Hill College Division, Holman, J. P. (2009). Heat transfer. McGraw-Hill, Neogi, P. (1996). Diffusion in polymers (Vol. 32). CRC Press, Rudin, A. and Choi, P. (2012). The elements of polymer science and engineering. Academic press and Smith J. M. et al. (2018). Introduction to chemical engineering thermodynamics. McGraw-Hill.

Pelletization is not an entirely uniform process and pellets can have a distribution of shapes and sizes. In the present disclosure, for the sake of simplicity, for the purpose of computational model, it was assumed that pellets are spherical in shape with a single diameter value (Sauter Mean Diameter) characterizing the distribution of the pellets size and shape. The Sauter Mean Diameter (d_{SM}) is defined as the diameter of a sphere whose ratio of volume (Vₚ) to surface area (Aₚ) is equal to that of a pelletized particle with an arbitrary shape (i.e., d_{SM} 6Vₚ/Aₚ).

Polymer pellets volume and surface area was determined using an optical method according to the following steps. First approximately 200 pellets laid flat on a black plate and photographed. To reduce inaccuracies due to transparency, the pellets were coated with icing sugar. An adaptive thresholding step was then applied to generate a binary image of the pellets. A clustering algorithm was used to extract each individual pellet allowing for the major and minor diameter of the pellets to be measured in pixels. The pixel to millimeter conversion factor was calculated by precisely measuring the base plate in mm and in pixels. The third dimension (or the thickness) of each pellet was then calculated based on the mass and density of the batch.

Mass transfer in the stripping bin is a multiphase, multicomponent process. In the present disclosure, it was assumed that the concentration gradient of each VOC component within each pellet is governed by Fickian mass diffusion in spherical coordinates according to:

$$ρ \frac{\partial {C}_{i}}{\partial t} = \frac{ρ {D}_{i}}{{r}^{2}} \frac{\partial }{\partial r} ( {r}^{2} \frac{\partial {C}_{i}}{\partial r} ) \qquad ( eq . 1 )$$

In the partial differential equation in eq. 1, Cᵢ was the concentration of the i-th VOC component as a function of time t and radial position r, p was the solid-state density of the ethylene/α-olefin copolymer material and Dᵢ was the diffusion coefficient of the i-th VOC component through the ethylene/α-olefin copolymer. The diffusion coefficient of the i-th VOC component in pellets was considered to be a constant and was mathematically described in the computational model using a simplified version of Free Volume theory correlating the diffusion coefficient of VOCs in pellets in terms of ethylene/α-olefin copolymer material solid-state density and temperature as follows:

$${D}_{i} = {10}^{6} {D}_{0 i} ρ \times exp ( \frac{- {C}_{1 i}}{T} ) \times exp ( {C}_{2 i} \frac{{ρ}_{0 i} - ρ}{{ρ}_{0 i} ρ} ) \qquad ( eq . 2 )$$

wherein ρ is the density of the ethylene/α-olefin copolymer material in solid-state and D₀ᵢ, −C₁ᵢ, C₂ᵢ and ρ₀ᵢ are model constants which can be determined experimentally for each VOC component (determined using Crank's spherical diffusion model by measuring each VOC components mass loss after a soaking step—see the Test Methods section under the subheading of Diffusion Coefficient of VOCs in the Ethylene/α-olefin Copolymer for a detailed description of the measurement method).

The partial differential equation in eq. 1 was solved to obtain temporal and radial variation of the i-th VOC component concentration in a pellet using proper initial and boundary conditions. Each VOC component initial concentration is a known value, e.g., Cᵢ=Cᵢ₀ at t=0 for all values of r (determined by measuring each VOC component level at the cutter location using GC analysis—see the Test Methods section under the subheading Volatile Organic Compounds (VOCs) Concentration for a detailed description of the measurement method). Using symmetry arguments, the first boundary condition, for i-th VOC component concentration gradient, at the center of pellets can be identified as ∂Cᵢ/∂r=0 at r=0 for all values of t.

The second boundary condition was defined to connect the pellet surface concentration at r=rₚ (rₚ≡ethylene/α-olefin copolymer pellet radius; rₚ=d_{SM}/2) to the bulk nitrogen concentration for all values of t as follows:

$$- ρ {D}_{i} \frac{\partial {C}_{i}}{\partial r} + \frac{{M}_{wi} {h}_{mi}}{{RT}_{N}} ( {p}_{iN} - {p}_{iN}^{*} ) = 0 \qquad ( eq . 3 )$$

wherein M_{wi} was the molecular weight of the i-th VOC component, R was the ideal gas constant and hit is the convective mass transfer coefficient of the i-th VOC component. In eq. 3, p_{iN}* is the i-th VOC component partial pressure in the boundary layer and p_{iN} is the i-th VOC component partial pressure in the nitrogen phase far from the boundary layer. In the present disclosure, the i-th VOC component partial pressure in the boundary layer p_{iN}* was assumed to be correlated linearly to the concentration of the i-th VOC component Cᵢ at r=rₚ with an isotherm slope of αᵢ (i.e., p_{iN}* αᵢCᵢ) wherein:

$${α}_{i} = {α}_{i 0} ( {a}_{i} MI + {b}_{i} ρ ) {e}^{- \frac{{E}_{i}}{RT}} \qquad ( eq . 4 )$$

in which ρ and MI are the density and melt index of the ethylene/α-olefin copolymer material measured according to ASTM D1505 and ASTM D1238 (at 190° C. under a 2.16 kg load). Model constants αᵢ₀, aᵢ, bᵢ and Eᵢ were determined for each VOC component using a GC head space analysis developed to accurately measure the desorption isotherms between VOCs and the ethylene/α-olefin copolymer pellets (see the Test Methods section under the subheading of Desorption Isotherms for Pellets—VOCs System for a detailed description). The mass flowrate of the i-th VOC component due to evaporation can be expressed at r=rₚ for all values t of as follows:

$${\dot{m}}_{ip} = - ρ {D}_{i} {A}_{p} \frac{\partial {C}_{i}}{\partial r} \qquad ( eq . 5 )$$

wherein A_{P} is pellet's surface area. One can further identify that the total mass flowrate of the i-th VOC component desorbed from the pellets bed would be \dot{m}ᵢ=Nₚ\dot{m}ᵢₚ wherein Nₚ is the number of pellets in each volume element along the height direction (z-direction) of pellets bed. The convective mass transfer coefficient hₘᵢ in eq. 3 for each VOC component was calculated as follows:

$$\begin{matrix}{Sc}_{i} = \frac{{μ}_{mix}}{{ρ}_{mix} {D}_{iN 2}} \\ Re = \frac{{ρ}_{mix} \hat{V} {D}_{p}}{{μ}_{mix}} \\ log ( {j}_{m} ) = - 0.34159 * log ( Re ) - 0.14226 \\ {St}_{mi} = \frac{{j}_{m}}{{Sc}_{i}^{2 / 3}} \\ {h}_{mi} = {St}_{mi} \hat{V}\end{matrix} \qquad ( eq . 6 )$$

wherein μₘᵢₓ, ρₘᵢₓ and D_{P} are vapor phase viscosity, vapor density, pellet's diameter and \hat{V} represents the superficial velocity defined as vapor phase volumetric flowrate divided by bin cross sectional area (A_{b}). The Chapman-Enskog-Wilke-Lee model and the Peng-Robinson EOS implemented in ASPEN Properties V10 were used to estimate the diffusion coefficient of the i-th VOC component in nitrogen environment (D_{iN2}) as a function of temperature. For the purpose of eq. 6, a linear function with a square of the correlation coefficient R² of unity was fitted to this data which was then applied to respective calculations. Dimensionless numbers Re, jₘ, Stₘᵢ and Scᵢ are Reynold's number, Chilton and Colburn J-factor for mass transfer in packed beds for the i-th VOC component, Stanton's number for mass transfer in packed beds for the i-th VOC component and Schmidt's number for the i-th VOC component.

The vapor phase comprises a mixture of varying percentages of nitrogen, at least one alpha-olefinic comonomer and the process solvent. Due to low pressure (˜1 atm) and temperature (maximum 85° C.) of the stripping process, the ideal gas law can be used for prediction of the vapor mixture density and viscosity of the vapor phase mixture at a temperature range of 40-85° C. and a pressure range of 100-120 kPa.

Using a simplified version of the Chapman-Enskog-Brokaw-Wilke mixing rule, the viscosity of the vapor mixture (μₘᵢₓ) was estimated as follows:

$${μ}_{mix} = {\sum }_{i} \frac{{γ}_{i} {μ}_{i}}{{γ}_{i} + {\sum }_{j} {γ}_{j} {ϕ}_{ij}} \qquad ( eq . 7 )$$

wherein yᵢ was mole fraction of the i-th component in the mixture, μᵢ was the viscosity of the i-th component and ϕᵢⱼ was (Mwⱼ/Mwᵢ)^{1/2} in which M_{w} and Mwᵢ were i-th and j-th components molecular weights. Accuracy of above estimation was evaluated against Peng-Robinson equation of state and transport properties models in ASPEN Properties V10. It was determined that the viscosity of the vapor mixture could be estimated by applying the simple mixing rules described in eq. 7 within an average error of 2.24%.

The mass advection along the bed height due to nitrogen flow was described on a mole basis (since partial pressure was used in here instead of mass concentration) as follows:

$$\frac{{A}_{b} ϵ}{{RT}_{N}} \frac{\partial {p}_{iN}}{\partial t} = \frac{{\dot{m}}_{N}}{{M}_{wN}} \frac{\partial ( {p}_{iN / {p}_{N}} )}{\partial z} + {A}_{b} ( 1 - ϵ ) \frac{3}{{r}_{p}} \frac{{\dot{m}}_{i}}{{M}_{wi}} \qquad ( eq . 8 )$$

wherein the ideal gas law has been used to translate molar concentration to partial pressure in eq. 8. The bed void fraction ϵ is a measure of bulk density of pellets which can be determined based on a gravimetric method having values in range of 0.34-0.42. Gas phase total pressure pₜ is equal to the sum of partial pressures of nitrogen and VOC components in eq. 3 (i.e., pₜ=p_{N}+Σᵢp_{iN}). The total gas phase pressure pₜ is subject to the pressure drop being calculated based on the nitrogen flowrate, bed void fraction E and bin diameter D (see eq. 9 and respective descriptions below).

The initial content of the i-th VOC component in the nitrogen phase (i.e., p_{iN} at t=0) was assumed to be at equilibrium with the i-th VOC component partial pressure in the boundary layer, i.e., p_{iN}=p_{iN0}* at t=0 for all values of z. This latter assumption has a short-lived impact on the obtained solution and is mainly intended for a smooth initialization of the simulation process. The boundary condition on the z-direction was the inlet nitrogen VOC concentration (partial pressure) where the p_{iN}=p_{iNinlet} at z=0 for all values of t.

In the present disclosure, the Ergun equation was used to estimate the pressure drop in the stripping bin:

$$\frac{{dp}_{t}}{dz} = \frac{150 μ {( 1 - ϵ )}^{2} \hat{V}}{{ϵ}^{3} {D}_{p}^{2}} + \frac{1.75 ( 1 - ϵ ) ρ {\hat{V}}^{2}}{{ϵ}^{3} {D}_{p}} \qquad ( eq . 9 )$$

wherein μ was the viscosity of the nitrogen phase and the rest of parameters had the same definition as above-described equations. In the present disclosure, a value of 0.35 was used for the purpose of computational model. It is worth noting that eq. 9 was used to describe the pressure drop in the bin, given the other parameters were known. To calculate the total pressure at any point in the bin, the pressure on one of the boundaries on the z-direction (i.e., top or bottom) should be known. Therefore, pressure at top of the bin was assumed to be constant and the pressure at the bottom of the bin was calculated based on the calculated pressure drop by eq. 9. A summary of the parameters used in eqs. 1 through 9 is presented in TABLE 3.

TABLE 3
Summary of the Parameters Used in the Mass Transfer
Computational Model in Egs. 1 through 9

| | Unit | Description |
|---|---|---|
| L | m | bed height |
| D | m | bed diameter |
| ρ | kg/m³ | ethylene/α-olefin interpolymer density in |
| | | solid state |
| t | s | time coordinate |
| r | m | spatial coordinate along pellets radius |
| i | — | counter on the VOC type (either process |
| | | solvent or unreacted 1-octene) |
| \dot{m}ᵢ | kg/s | total evaporation rate of the i-th VOC at the |
| | | pellet surface (\dot{m}ᵢ = Nₚ\dot{m}ᵢₚ) |
| \dot{m}ᵢₚ | kg/s | evaporation rate of the i-th VOC at the pellet |
| | | surface |
| Nₚ | — | number of pellets in each volume element |
| T_{N} | ° C. | bulk nitrogen temperature |
| rₚ | m | pellet radius |
| Aₚ | m² | pellet surface area |
| ρ_{N} | kg/m³ | nitrogen density |
| A_{b} | m² | bed cross-sectional surface area |
| ∈ | — | bed void fraction |
| \dot{m}_{N} | kg/s | nitrogen mass flowrate |
| z | m | spatial coordinate along bed height |
| Cᵢ | kg VOC/kg | concentration of the i-th VOC in the solid |
| | polymer | ethylene/α-olefin interpolymer |
| Dᵢ | m²/s | diffusion coefficient of the i-th VOC in the |
| | | solid ethylene/α-olefin copolymer |
| p_{iN} | kPa | i-th VOC partial pressure in gas phase |
| p_{iN}* | kPa | i-th VOC partial pressure in the boundary |
| | | layer |
| p_{N} | kPa | nitrogen partial pressure in the gas phase |
| pₜ | kPa | gas phase total pressure |
| hₘᵢ | m/s | i-th VOC mass convection coefficient |
| | | between pellets surface and bulk of N₂ |
| M_{wi} | kg/kmol | i-th VOC molecular weight |
| M_{wN} | kg/kmol | nitrogen Molecular weight |
| R | kPa · m³/mol · K | ideal gas constant |

### Example 3: Validation of the Stripping Bin Computational Model

In this Example, equations described in Example 2 (eq. 1 through 9) were solved numerically using method of lines by discretizing the spatial derivatives (along the stripping bin axial direction (z-direction) and along pellets radial direction) and using a standard solver for solving the resulting ordinary differential equations in time domain. Number of discrete points along z-direction was 25 and number of discrete points along pellets radius was 15. This discretization step led to a system of ordinary differential equations to which a numerical method for initial value ordinary differential equations was subsequently applied in Python using the “odeinit” within “scipy” package which uses the well-established “ODEPACK” developed in “fortran77” by Alan Hindmarsh from Lawrence Livermore National Laboratory.

According to the above-described numerical scheme, in the pellets stripping process, mass was not produced or consumed (merely transferred from one phase to another phase). Thus, the overall mass balance for the two phases were equal at any point in time. In the implementation of the numerical method in Python, a routine was implemented to check for conservation of mass. This routine keeps track of the mass transferred to or from each phase separately (pellets and nitrogen).

For the purpose of validating the mass transfer computational model, a bivariate B-spline representing temperature variations as a function of time and height was fitted to the Test Stripper experimental temperature readings for each test run tabulated in TABLE 2. The B-spline representation was then imported into the mass transfer computational model described in Example 2.

In eq. 2, D₀ᵢ, −C₁ᵢ, C₂ᵢ and ρ₀ᵢ are model constants were determined experimentally for each VOC component using Crank's spherical diffusion model by measuring each VOC component mass uptake after a soaking step (see the Test Methods section under the subheading of Diffusion Coefficient of VOCs in the Ethylene/α-olefin Copolymer for a detailed description of the measurement method). In this Example, for 2-methylpentane, D₀ had a value of 2.44×10−3 kg·m⁻¹ s⁻¹, C₁ had a value of 4752.3 K, C₂ had a value of 18.77 kg·m⁻³ and ρ₀ had a value of 0.60 kg·m⁻³. Similarly, 1-octene had a D₀ of 2.01×10⁻⁷ kg·m⁻¹ s⁻¹, a C₁ of 6731.6 K, a C₂ of 25.17 kg·m⁻³ and a ρ₀ of 1.07 kg·m⁻³.

In eq. 4, model constants αᵢ₀, aᵢ, bᵢ and Eᵢ were determined for each VOC component using a GC head space analysis developed to accurately measure the sorption isotherms between VOCs and the ethylene/α-olefin copolymer material (see the Test Methods section under the subheading of Desorption Isotherms for Pellets—VOCs System for a detailed description). In Example 3, for 2-methylpentane, α₀ had a value of 2092860 kPa·kg(resin)·kg(VOC)⁻¹, a had a value of 0.1255 (dimensionless), b had a value of 25.354 kPa·m³·kg(VOC)⁻¹ and E/R had a value of 3750.375 K. Similarly, 1-octene had an α₀ of 80000 kPa·kg(resin)·kg(VOC)⁻¹, a a of −0.3955 (dimensionless), a b of 96.795 kPa·m³·kg(VOC)⁻¹ and a E/R of 3900 K.

For validation of the model, measured VOCs concentration values at SP1, SP3 and SP5 under operating conditions shown in TABLE 2 are coplotted with the model predictions (shown in solid lines) in FIGS. 1 through 3. As can be seen, model predictions were either in good agreement or more conservative than experimental data. It should be noted that none of the mass transport properties fed to the model has been regressed to improve the model predictions.

### Example 4: Annealing Heat Treatment

In this example, an annealing treatment at an appropriate temperature and for a sufficient period of time was applied to an ethylene/1-octene copolymer prepared in substantial accordance with the teachings of Kazemi et al. in the U.S. Pat. No. 10,995,166. The ethylene/1-octene copolymer in this Example had a density of 0.8798 g/cm³, a melt index MI₂ of 0.49 dg/min, a highest peak melting temperature Tₘ of 68° C. and a VICAT softening point (VSP) of 54.9° C. (measured according to ASTM D1525-17 on a specimen prepared by compression molding and then rapidly cooling from melt to 10° C.).

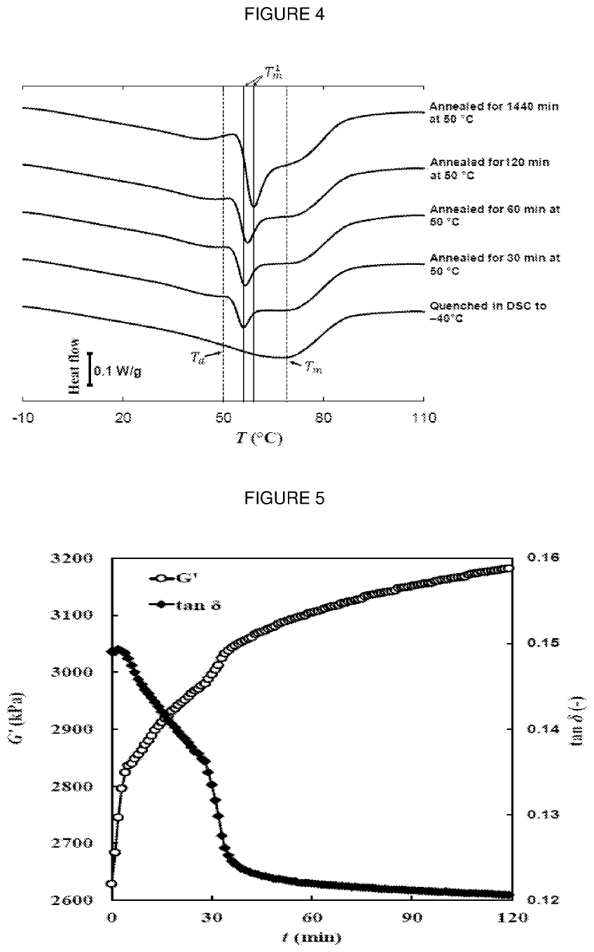

For this purpose, an annealing treatment involving a step of maintaining isothermal conditions in a DSC chamber at an annealing temperature (Ta) of 50° C. which was less than VSP of the ethylene/α-olefin copolymer and greater than VSP−30° C. (i.e., VSP−30<Tₐ<VSP; where VSP=54.9° C.) was applied to the ethylene/α-olefin copolymer specimen to partially melt the resin and to introduce a new peak melting temperature Tₘ¹ greater than Tₐ and less than the highest peak melting temperature Tₘ of the ethylene/α-olefin copolymer. As shown in FIG. 4, Tₘ¹ monotonically increased as annealing time increased—e.g., Tₘ¹ had a value of 56.1° C., 56.6° C., 57.4° C. and 59.1° C. after annealing at 50° C. for 0.5, 1, 2 and 24 hours, respectively. Without wishing to be limited by any theory, it is believed that the observed new peak melting temperature Tₘ¹, at a molecular level, was the result of partial melting of the crystalline phase in the ethylene/α-olefin copolymer sample during the annealing step which liberated polymer chains from the lamellae with a melting temperature lower than the annealing temperature slowly facilitating their refolding into more thermodynamically stable crystalline structures with a higher melting temperature.

TABLE 4 further reveals the impact of annealing at 50° C. for 2 h on the VICAT softening temperature of the ethylene/1-octene copolymer. In the case of VICAT softening temperature before annealing, disc-shaped samples were prepared from the ethylene/1-octene copolymer by compression molding at a temperature of 165° C. for 10 minutes and then immediately quenching the molding assembly to about 10° C. at a cooling rate of about 50° C./min (i.e., mold/two mylar sheets/samples/two cull plates assembly were submerged in an ice/water bath). The mold had dimensions of 22.9 cm×22.9 cm×0.5 cm, with 9 circular cavities arranged in a 3×3 pattern. The mold cavities had a diameter of 3.8 cm. The quenched samples were then immediately removed from the bath and were transferred for testing to the VICAT softening temperature measurement unit. The quenched ethylene/α-olefin copolymer according to above procedure had a VICAT softening temperature of 54.9° C. with a standard deviation of 0.9° C. (based on 16 measurements).

Another set of samples were prepared from the ethylene/α-olefin copolymer by compression molding and then immediately transferring mold/two mylar sheets/samples/two cull plates assembly into a pre-heated oven at 50° C. The assembly was annealed for 2 hours in the pre-heated oven. After the 2 h annealing step, the assembly was removed from the oven and air-cooled to room temperature before testing for its VICAT softening. Application of the annealing heat treatment raised resin's VICAT softening to 59.4° C. with a standard deviation of 1.7° C. (a ˜5° C. increase when compared to the quenched baseline).

It was further observed that the applied annealing heat treatment, where Tₐ satisfied an inequality according to VSP−30<Tₐ<VSP, induced improvement in the elastic modulus of the ethylene/1-octene copolymer. As shown in FIG. 5, the ethylene/1-octene copolymer elasticity (G′) increased by about 14% with the first 30 min of annealing at 50° C. followed by a slower rate of increase reaching 21% improvement after 120 min of annealing at a frequency of 70 rad/s (the 70^{th} harmonic). One should notice that the increase in elasticity was accompanied by a decrease in damping factor (tan δ).

TABLE 4
Annealing Heat Treatment

| | | |
|---|---|---|
| Resin Density | g/cm³ | 0.8798 |
| Resin Melt Index | dg/min | 0.49 |
| Peak Melting Temperature, Tₘ | ° C. | 68 |
| Annealing Temperature, Tₐ | ° C. | 50 |
| Annealing Duration | h | 2 |
| VICAT Softening Point Before Annealing | ° C. | 54.9 |
| VICAT Softening Point After Annealing | ° C. | 59.4 |

### Example 5: Commercial-Scale Operation

The experiments disclosed in Example 4 indicated that annealing treatment at an appropriate temperature for a sufficient period of time according to the teachings of the present disclosure raised the threshold for temperature softening and improved the elasticity of the ethylene/α-olefin copolymer concurrent with a decrease in its damping factor. One of skill in the art is cognizant that increase in the elasticity of the ethylene/α-olefin copolymer, when in pellet form, reduces the wetted area between neighboring pellets. Likewise, decrease in the damping factor deteriorates ability of the wetted area to bear debonding forces (e.g., those exerted by pellets weight). This enables continuing the devolatilization process at a higher nitrogen inlet temperature with no major risk of blocking the devolatilization bin in areas where pellets experience a high consolidation pressure. As will be shown in this Example, devolatilization using a multiple temperature sequence reduced the holdup time required to devolatilize the ethylene/α-olefin copolymer pellets to a target VOCs level which can significantly reduce the operating cost.

In this example, a commercial-scale batch stripping process in a silo-shaped devolatilization bin with a capacity of 200×10³ kg is simulated and analyzed to assess the impact of employing a multiple temperature devolatilization treatment on the holdup time (HUT) required to decrease pellets overall VOCs content to 150 ppm. This analysis was performed on the ethylene/1-octene copolymer describe in detail in Example 4 using the mathematical model described in Example 2 under two different conditions; namely a base-case scenario where nitrogen was provided to the devolatilization bin at a constant nitrogen inlet temperature and a multiple temperature devolatilization process where the nitrogen inlet temperature was initially provided at a first inlet temperature of (T_{N}^{inlet})¹ for a first period of time and was then raised and held at a higher nitrogen inlet temperature (T_{N}^{inlet})² for a second period of time.

The devolatilization bin in Example 5 comprised an upper cylindrical portion with a height of 24.0 m and a base diameter of 4.5 m. The devolatilization bin further comprised a truncated conical portion with a top diameter of 4.5 m, a height of 3.5 m and a bottom diameter of 0.6 m.

In this Example, a multi-phase heat transfer model was developed and solved simultaneously with the mass transfer computational model described in Example 2. The multi-phase heat transfer model in this Example was defined based on heat conduction within pellets, heat convection between pellets surface and the bulk nitrogen phase, VOCs latent heat of evaporation and heat advection representing the enthalpy transfer along the bed height by nitrogen flow.

Thermal conduction in each pellet was described by the Fourier's law in spherical coordinates:

$$ρ {C}_{p} \frac{\partial T}{\partial t} = \frac{k}{{r}^{2}} \frac{\partial }{\partial r} ( {r}^{2} \frac{\partial T}{\partial r} ) \qquad ( eq . 10 )$$

wherein ρ, Cₚ and k were the density, specific heat-capacity and thermal conductivity of the ethylene/α-olefin copolymer material in the solid state. The partial differential equation in eq. 10 was solved using appropriate initial and boundary conditions to yield temporal variation of temperature within pellets along their radius (i.e., T=T(r,t)). In this Example, a constant thermal conductivity k of 0.2 W/m·K was implemented for the purpose of solving the partial differential equation in eq. 10. A linear relationship with temperature t (in ° C.) and resin density ρ (in g/cm³) was used to estimate the specific heat-capacity Cₚ (in J/kg.° C.) of the ethylene/α-olefin copolymer in eq. 10 as follows:

$${C}_{p} = 1000 \times [ ( 0.2648 ρ - 0.2172 ) \times t + ( - 12.2172 ρ + 12.9296 ) ] \qquad ( eq . 11 )$$

The pellets were heated to a pre-determined initial temperature (T₀) before entering the stripping bin, and thus their initial temperature at t=0 was T₀ for all values of r. For symmetry reasons, the first boundary condition was defined as ∂T/∂r=0 at the pellet center for all values of t. The second boundary condition was used to connect the pellet surface temperature (i.e., the temperature at r=rₚ; where rₚ=d_{SM}/²) to the bulk nitrogen temperature (T_{N}) and evaporation of VOCs as defined below:

$$- {kA}_{p} \frac{\partial T}{\partial r} - {\sum }_{i} {m}_{ip} {H}_{i} + {h}_{h} {A}_{p} ( {T}_{N} - T ) = 0 \qquad ( eq . 12 )$$

wherein Aₚ, \dot{m}ᵢₚ, Hᵢ and hₕ are pellet surface area, the i-th VOC evaporation mass flowrate at the pellet surface, the i-th VOC latent heat of evaporation and heat convection coefficient between pellets surface and bulk of nitrogen, respectively. Each VOC component latent heat of evaporation could be estimated using known equations of state in the art. One example of an appropriate equation of state is the PC-SAFT equation of state with the proper parameters (e.g., see Gross, J., & Sadowski, G. (2001). Perturbed-chain SAFT: An equation of state based on a perturbation theory for chain molecules. Industrial & engineering chemistry research, 40(4), 1244-1260.). Close to atmospheric pressures, the heat of evaporation is not a strong function of pressure. Thus, in the present disclosure, a temperature dependent equation has been fitted to the values predicted by PC-SAFT for numerical purposes.

In Example 5, the latent heat of evaporation (in kJ/kg) of the first (2-methylpentane) and the second (1-octene) VOC components using the PC-SAFT model predictions can be described as a function of temperature (in ° C.) using the following linear relationships:

$$\begin{matrix}{H}_{1 - octene} = - 0.5715 T + 376.77 \\ {H}_{2 - methylpentane} = - 0.6412 T + 358.67\end{matrix} \qquad ( eq . 13 )$$

The convective heat transfer coefficient between pellets surface and bulk of nitrogen (hₕ) was calculated according to generally known correlations in chemical engineering literature (e.g., see Barker, J. J. (1965). Heat transfer in packed beds. Industrial & Engineering Chemistry, 57(4), 43-51) as follows:

$$\begin{matrix}Pr = \frac{{μ}_{mix} {C}_{pmix}}{k} \\ Re = \frac{{ρ}_{mix} \hat{V} {D}_{p}}{μ} \\ log ( {j}_{h} ) = - 0.34159 * log ( Re ) - 0.14226 \\ {St}_{h} = \frac{{j}_{h}}{{Pr}^{2 / 3}} \\ {h}_{h} = {St}_{h} {ρ}_{mix} {C}_{pmix} \hat{V}\end{matrix} \qquad ( eq . 14 )$$

wherein Pr, Re, jₕ and Stₕ are Prandtl's number, Reynold's number, Chilton and Colburn J-factor for heat transfer in packed beds and Stanton's number for heat transfer in packed beds, respectively. In eq. 14, μₘᵢₓ, Cₚₘᵢₓ, kₘᵢₓ and ρₘᵢₓ are vapor phase viscosity, specific heat capacity, thermal conductivity and density and the terms Dₚ and \hat{V} represent pellet diameter and the superficial velocity defined as vapor phase volumetric flowrate divided by bin cross sectional.

Knowing the composition of the vapor phase (mixture of nitrogen and VOCs), temperature and pressure, Peng-Robinson equation of state could be used to predict the transport properties of the vapor phase. The vapor phase comprises a mixture of varying percentages of nitrogen, at least one α-olefinic comonomer and the process solvent. However, due to low pressure (˜1 atm) and temperature (limited by the VSP of the ethylene/α-olefin copolymer) of the stripping process, the ideal gas law can be used for prediction of the vapor mixture density of the vapor phase mixture at a temperature range of 40-85° C. and a pressure range of 100-120 kPa. This assumption was checked and confirmed by comparing the ideal gas predictions to those of Peng-Robinson equation of state (EOS) in ASPEN Properties V10.

In this context, by assuming ideal gas properties, the specific heat capacity Cₚₘᵢₓ and thermal conductivity kₘᵢₓ (denoted as Bₘᵢₓ in eq. 15) were estimated by applying a simple mixing rules as follows:

$${B}_{mix} = {\sum }_{i} {A}_{i} {x}_{i} \qquad ( eq . 15 )$$

wherein Aᵢ was ideal gas property of the i-th component in the vapor phase, xi was the mass fraction of the i-th component. Using a simplified version of the Chapman-Enskog-Brokaw-Wilke mixing rule, the viscosity of the vapor mixture (μₘᵢₓ) was estimated as follows:

$${μ}_{mix} = {\sum }_{i} \frac{{γ}_{i} {μ}_{i}}{{γ}_{i} + {\sum }_{j} {γ}_{j} {ϕ}_{ij}} \qquad ( eq . 16 )$$

wherein yᵢ was mole fraction of the i-th component in the mixture, μᵢ was the viscosity of the i-th component and ϕᵢⱼ was (Mwⱼ/Mwᵢ)^{1/2} in which Mwⱼ and Mwᵢ were i-th and j-th components molecular weights. Accuracy of above estimations were evaluated against Peng-Robinson equation of state and transport properties models in ASPEN Properties V10. It was determined that the specific heat capacity, thermal conductivity and viscosity of the vapor mixture could be estimated by applying the simple mixing rules described in eqs. 15 and 16 within an average error of 0.47%, 1.40% and 2.24%, respectively.

The local and temporal variation of the bulk nitrogen temperature (T_{N}) was determined based on the heat advection due to nitrogen flow along the bed height as follows:

$${ρ}_{N} {C}_{pN} {A}_{b} ϵ \frac{\partial {T}_{N}}{\partial t} = {\dot{m}}_{N} {C}_{pN} \frac{\partial {T}_{N}}{\partial z} - {A}_{b} ( 1 - ϵ ) \frac{3}{{r}_{p}} {h}_{h} ( {T}_{N} - T ) \qquad ( eq . 17 )$$

wherein ρ_{N}, C_{pN}, A_{b}, ϵ, \dot{m}_{N} and z are nitrogen density, nitrogen heat capacity, pellets bed cross-sectional surface area, bed void fraction, nitrogen mass flow rate and spatial coordinates along the pellets bed height, respectively. As can be seen, heat conduction in the nitrogen phase along the bed height has been neglected due to high superficial velocity of nitrogen. In the computational model in the Example 5, the bed void fraction E had a value of 0.35.

For smooth initialization of the problem, the initial temperature of nitrogen was assumed to be at equilibrium with pellets, i.e., T_{N} T₀ at t=0 for all values of z. This did not introduce any error in the calculations as the initial nitrogen content in the bed will leave the process within seconds. The boundary condition required to solve this equation was the inlet nitrogen temperature, i.e., T_{N} T_{Ninlet} at z 0 for all values of t. The inlet nitrogen temperature T_{Ninlet} is known as nitrogen stream is heated to a specific temperature before entering the bin.

At time zero there was no pellets in the bin and the bin was filled at a rate of 53.4×10³ kg/h taking about 4 h to reach capacity of the bin at 200×10³ kg. An algorithm according to the following steps was applied to incorporate the filling stage into the mathematical model:
(a) time required to fill one discrete node t_{node} in the bin was calculated based on the node capacity and production rate;
(b) first node is loaded with pellets and is simulated for duration of t_{node};
(c) second node is loaded with pellets and both nodes are simulated for duration of t_{node}; and
(d) steps (a) and (b) were continued until all the nodes are filled and bin is full.

Assuming the total time for filling the bin is t_{fill}, the devolatilization in the model was only simulated during the time period of t_{fill}−t_{node}. This sequence was intentionally designed to underestimate the level of devolatilization happening during the filling period, therefore the required HUT for stripping was always overestimated by a time ranging from 0 to t_{node}. A similar approach was taken during the interval where the devolatilization bin was emptied.

During the stripping process, pellets were recirculated from the bottom to the top of the bed at a certain frequency and rate. A recirculation rate of 5.0×10³ kg/h was applied for 10 minutes in every hour in the current Example. Thereby, the Hourly Recirculation Rate (HRR) is 1.67×10³ kg/h. An algorithm according to the following steps was applied at the end of each hour during simulation to incorporate the recirculation process by:
(a) continuing the stripping process for a period of time in hours defined by node mass (mass of pellets in each node) divided by HRR;
(b) removing the first node at the bottom of the bin;
(c) shifting all other nodes down by one node; and
(d) placing the first node at the top.

A base-case scenario was developed for stripping of the ethylene/α-olefin copolymer pellets at 47° C. where pellets and nitrogen enter the stripping area at 47° C. (see TABLE 5 for process variables). In the case of devolatilization using the inventive process, the same computational model was applied to simulate a devolatilization process where pellets entered the devolatilization bin with an initial temperature of 47° C., subsequent to the filling step a nitrogen inlet temperature of 47° C. (T_{N}^{inlet})¹ was applied for 15 h and then the nitrogen inlet temperature was raised and held at a higher temperature (T_{N}^{inlet})² of 52° C. The stripping HUT required for the base case was 69.3 h which dropped to 64.2 h in the case of the inventive process where a multiple temperature sequence is applied.

TABLE 5
Annealing/Stripping Treatment

| | | |
|---|---|---|
| Bin Capacity | kg | 200 × 10³ |
| Bin Top Pressure | kPa | 109 |
| Bin Diameter | m | 4.5 |
| Pellets Filling Rate | kg/h | 53.4 × 10³ |
| Pellets Initial Temperature | ° C. | 47 |
| Pellets Initial VOCs | wt % | 2.26 |
| Pellets Size | # pellets/g | 40 |
| Bed Void Fraction | — | 0.35 |
| Pellets Final VOCs Content | ppm | 150 |
| Nitrogen Flowrate | kg/h | 10 × 10³ |
| Nitrogen Purity | ppm of VOCs | 50 |
| Pellets Emptying Rate | kg/h | 67.0 × 10³ |

### INDUSTRIAL APPLICABILITY

Disclosed herein is a process for the devolatilization of ethylene/α-olefin copolymer pellets. The ethylene α-olefin copolymers have a wide variety of industrial uses; a non-limiting example for the ethylene α-olefin copolymers having a density from 0.865 to 0.905 g/cm³ is preparation of a sealant layer in a multilayer flexible packaging film.

1. A process for devolatilization of ethylene/α-olefin copolymer pellets, wherein the ethylene/α-olefin copolymer has a VICAT softening temperature (VSP) measured by ASTM D1525-17 and a highest peak melting temperature Tₘ, wherein the process comprises:
a) filling a devolatilization bin at a filling time t_{f} with the ethylene/α-olefin copolymer pellets, wherein the ethylene/α-olefin copolymer pellets are characterized by containing greater than or equal to 1 weight % of residual volatile hydrocarbons;
b) providing nitrogen gas to the devolatilization bin at a first nitrogen inlet temperature (T_{N}^{inlet})¹ for a first period of time t₁ subsequent to the filling time t_{f}, wherein (T_{N}^{inlet})¹ is greater than VSP−30° C. and less than the VSP of the ethylene/α-olefin copolymer and wherein the first period of time t₁ is sufficient to form a new peak melting temperature Tₘ¹ in the ethylene/α-olefin copolymer, wherein Tₘ¹ is greater than (T_{N}^{inlet})¹ and less than the highest peak melting temperature Tₘ;
c) raising and holding the nitrogen gas temperature provided to the devolatilization bin at a second nitrogen inlet temperature (T_{N}^{inlet})² for a second period of time t₂ subsequent to the first period of time t₁, wherein (T_{N}^{inlet})² is greater than (T_{N}^{inlet})¹ and less than Tₘ¹; and
d) discharging the ethylene/α-olefin copolymer pellets from the devolatilization bin at a third period of time t₃ subsequent to the second period of time t₂;
wherein the ethylene/α-olefin copolymer pellets contain less than or equal to 150 parts per million of the residual volatile hydrocarbons after a holdup time (HUT) corresponding to sum of the filling time in the step a), the first period of time t₁ in the step b), the second period of time t₂ in the step c) and the third period of time t₃ in the step d).

2. The process of claim 1, wherein the ethylene/α-olefin copolymer has a density from 0.865 to 0.905 g/cm³ as measured by ASTM D1505 and a melt index MI₂ from 0.3 to 30 dg/min as measured by ASTM D1238 at a temperature of 190° C. using a 2.16 kg load.

3. The process of claim 1, wherein the first nitrogen inlet temperature (T_{N}^{inlet})¹ in the step b) is greater than VSP−15° C. and less than or equal to VSP−5° C. of the ethylene/α-olefin copolymer.

4. The process of claim 3, wherein the first nitrogen inlet temperature (T_{N}^{inlet})¹ in the step b) is from 40 to 85° C.

5. The process of claim 3, wherein the first nitrogen inlet temperature (T_{N}^{inlet})¹ in the step b) is from 40 to 70° C.

6. The process of claim 1, wherein the ethylene/α-olefin copolymer pellets entering the devolatilization bin in the step a) are characterized by containing less than or equal to 5 weight % of the residual volatile hydrocarbons.

7. The process of claim 1, wherein the new peak melting temperature Tₘ¹ is from 5 to 15° C. above the first nitrogen inlet temperature (T_{N}^{inlet})¹.

8. The process of claim 1, wherein the first period of time t₁ in the step b) is sufficient to increase elastic modulus of the ethylene/α-olefin copolymer by at least 15%.

9. The process of claim 1, wherein said ethylene/α-olefin copolymer comprises ethylene and at least one α-olefin selected from the group consisting of 1-butene, 1-hexene and 1-octene.

10. The process of claim 1, wherein the ethylene/α-olefin copolymer pellets are not fluidized in the devolatilization bin during the steps b) and c).

11. The process of claim 10, wherein the devolatilization bin has a top end wall and a bottom end wall, and a continuous sidewall therebetween, and wherein the nitrogen gas is continuously provided to a first area proximal the bottom end wall using a plurality of feed nozzles as an upward flow to the devolatilization bin at a mass flow rate from 2 weight % to 15 weight % per hour, based on the total weight of ethylene/α-olefin copolymer pellets in the devolatilization bin.

12. The process of claim 11, wherein the ethylene/α-olefin copolymer has a density from 0.865 to 0.900 g/cm³ as measured by ASTM D1505 and wherein an amount of ethylene/α-olefin copolymer pellets are periodically recirculated from a second area proximal to the bottom end wall of the devolatilization bin to a third area proximal to the top end wall of the devolatilization bin during any or both of the steps b) and c) using a conveying means external to the devolatilization bin, wherein the conveying means extends from a first opening positioned adjacent the second area proximal the bottom end wall of the devolatilization bin to a second opening positioned adjacent the third area proximal to the top end wall of the devolatilization bin.

13. The process of claim 12, wherein the amount of ethylene/α-olefin copolymer pellets that are recirculated is from about 0.5% to about 5% of the total weight of ethylene/α-olefin copolymer pellets are recirculated over a recirculation time of 10 minutes at least every 8 hours for the ethylene/α-olefin copolymer density range from 0.865 to 0.885 g/cm³ or at least every 16 hours for the ethylene/α-olefin copolymer density range from 0.885 to 0.900 g/cm³.

14. The process of claim 12, wherein the conveying means is a pneumatic conveying means which uses nitrogen gas as motive gas.
